(19) United States
(12) Patent Application Publication
(10) Pub. No.: US 2022/0374585 A1
(43) Pub. Date: Nov. 24, 2022

(54) USER INTERFACES AND TOOLS FOR FACILITATING INTERACTIONS WITH VIDEO CONTENT

(71) Applicant: GOOGLE LLC, Mountain View, CA (US)

(72) Inventors: Xin Wang, Belmont, CA (US); Li Lin, Menlo Park, CA (US); Andy Russell, Menlo Park, CA (US)

(21) Appl. No.: 17/303,075

(22) Filed: May 19, 2021

(51) Int. Cl. G06F 40/169; H04L 29/06; G06F 16/955; G06F 3/0485

(52) U.S. Cl. CPC G06F 40/169; H04L 65/4015; H04L 65/601; G06F 16/955; G06F 3/0485

(57) ABSTRACT

Systems and methods are described that include causing a recording to begin capturing video content. The video content may include a presenter video stream, a screencast video stream, and an annotation video stream. The systems and methods may include generating, based on the video content and during capture of the video content, a metadata record representing timing information used to synchronize at least one portion of the video content to input received in at least one of the presenter video stream, the screencast video stream, or the annotation video stream.

### BACKGROUND

When giving presentations, presenters often have to repeat instructions and information to explain a concept to a group of users. In turn, each user typically takes notes on the concept so as to enable further review of the notes at a later time. A presenter may repeat the concept less often if a recording is generated from the presentation. However, conventionally recorded videos may not provide an easy way for users to find specific content within the video without watching and/or scanning the entire video. That is, when users are looking for a concept in a video, the user will have to watch or scroll through an entire recording to locate the concept.

### SUMMARY

The systems and methods described herein may provide a number of user interfaces (UIs) and/or presentation tools to facilitate interactions with video content. For example, the tools may facilitate recording, sharing, viewing, searching, and casting video content. The video content may be instructional, presentational, and/or otherwise based on information and input provided by any number of presenters and consumed by any number of users. The systems and methods described herein may provide, execute, and/or control the UIs and presentation tools based on commands received from an application (e.g., a browser, a web app, a native application, and the like) and/or commands received from an operating system (O/S) of a computing device. In some implementations, the UIs and presentation tools described herein may be provided in a hybrid combination of information from both an application and an O/S. For example, portions of the tools, UIs, and related instructional content (e.g., video content, files, annotations, etc.) may be provided by different application-triggered or O/S-triggered sources.

The systems and methods described herein may present presentation tools that include at least an interactive toolbar with a number of selectable tools (e.g., screencast, record screencast, presenter camera (e.g., a front-facing (i.e., selfie) camera), real time transcription, real time translation, laser pointer tools, annotation tools, magnifier tools). The toolbar may be configured for a presenter to easily present, record, cast with a single input. In addition, the toolbar may provide options to toggle the presentation, recording, and/or casting. For example, particular tools and/or screen content may be configured to be toggled on and off during recording. In some implementations, particular tools to toggle toolbars, screen content, and/or video streams associated with the video may also be provided to a viewer of a recording (either in real time or post-recording). For example, particular elements (e.g., a front-facing camera stream of a presenter, a transcript stream, a translation stream, an annotation stream, etc.) of a recording may be toggled on or off during the recording and/or during user reviews of the recording.

The systems and methods described herein are configured to enable the presentation tools to trigger sharing of content from one or more computer displays. The presentation tools may allow presenters and/or users to annotate (i.e., make annotations) on the shared content in an effective manner. The annotations may be stored such that the annotations may be later retrieved and aligned with timestamps and video content in order to be accurately placed on the shared content. For example, content may be annotated upon during the video recording and/or cast of content. The annotations may be layered onto the content (e.g., underlying application content) and stored in metadata so the annotations can be removed or adapted to be properly positioned to move with the content when a window event is detected (i.e., the annotations move when the window is scrolled or resized or moved across the UI). For example, if the presenter switches to another document during a recording (or scrolls within the document), an annotation layer is saved using metadata in order to trigger the appropriate annotations to be overlayed on the appropriate content when the presenter switches between documents throughout a recording for example. This may allow for multiple sources to be used to portray a concept and may allow for the presenter to place markup annotations on the content in an overlay layer (i.e., rather than in a word processing edit) to allow the overlay layer to be removed and reapplied as a presenter or user requests to remove or reapply the layer.

The systems and methods described herein may store annotations such that a presenter or user may switch between a number of documents, applications, or other recorded content (accessed while the recording occurred) while annotating such content and the annotations may be retrieved and provided as an overlay with the annotations properly positioned as performed during the video recording. Screen content, presenter camera captured content, transcription content, translation content, and annotation content may be configured to be toggled on and off during recording and post recording (i.e., during presenter view and user view).

In some implementations, the presentation tools described herein include an annotation tool configured to allow a presenter or user to indicate chapters within content, key ideas within content using one or more markup tools during a recording. The markup tools may include any number of input mechanisms including text input, laser pointer (and/or cursor, controller input, etc.) pen input, highlight input, shape input, and the like.

In some implementations, the systems and methods described herein may generate and display real time transcriptions and/or translation of audio content and video content. The transcriptions and/or translations may be depicted on a screen alongside other instructional content. In some implementations, the transcription and/or translations may be generated and then curated for later viewing. For example, a transcript may be formatted for ease of review and formatted for receiving annotations from a presenter or user in which the annotations may indicate a particular concept of the content as an important concept to learn.

The systems and methods described herein may include a tool for performing, formatting, and displaying translations and/or transcriptions of video content. When viewing video (during or after recording), users may scroll (e.g., video scroll) the content (e.g., webpages, documents, etc.) and in response, the transcript portions may automatically scroll synchronously with the video scroll. This synchronicity between video and text content can facilitate effective and resource efficient searching of content contained within videos, since the corresponding text can be used for searching.

In some implementations, the annotations and transcripts may be used to automatically generate recap (e.g., summary) videos representing portions of the recorded video content. The systems and methods described herein may configure the annotations and the transcribed audio to be searchable (and/or indexed) to be surfaced with a search provide in an application (e.g., browser) and/or O/S of a computing device accessing the recorded video content.

In some implementations, the presentation tools described herein may include magnifier tools that allow zoom in or zoom out modes based on a single input. The magnifier tools may be used without having to resize windows or web pages manually. In addition, the magnifier tools may be used in combination with the annotation tools. The annotations may be automatically resized with the video content to match the annotated content when a user exits either a zoom in or zoom out mode. This resizing enables the annotations to be stored via metadata, which may be later retrieved and applied as an overlay to the content without the annotation or zoomed content being mis-sized upon review of video content subsequent to the end of the recording.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In a first general aspect, a computer-implemented method is described that includes causing a recording to begin capturing video content, the video content including a presenter video stream, a screencast video stream, and an annotation video stream and generating, based on the video content and during capture of the video content, a metadata record representing timing information used to synchronize at least one portion of the video content to input received in at least one of the presenter video stream, the screencast video stream, or the annotation video stream.

Implementations can include any or all of the following features. In some implementations, in response to termination of the recording, the method may include generating, based on the metadata record, a representation of the video content, the representation including portions of the video content annotated by a user associated with the presenter video stream. In some implementations, the timing information corresponds to a plurality of timestamps associated with a respective input of the received input and at least one location in a document associated with the video content and synchronizing the input includes matching, for the respective input, at least one timestamp in the plurality of timestamps, to the at least one location in the document.

In some implementations, the video content further includes a transcription video stream and the transcription video stream includes real-time transcribed audio data from the presenter video stream generated as modifiable transcription data configured for display with the screencast video stream during the recording of the video content. In some implementations, the transcription video stream also includes real-time translated audio data from the presenter video stream generated as textual data configured for display with the screencast video stream and the transcribed audio data during the recording of the video content. In some implementations, the transcription of the real-time transcribed audio data is performed by at least one speech-to-text application where the at least one speech-to-text application selected from a plurality of speech-to-text applications determined to be accessible by the transcription video stream, and the modifiable transcription data and the textual data are stored according to timestamp in the metadata record and are configured to be searchable.

In some implementations, the input includes annotation input associated with the annotation video stream where the annotation input including video marker data and telestrator data generated by a user associated with the presenter video stream. In some implementations, the presenter video stream, the screencast video stream, and the annotation video stream are configured to be toggled on and off during the recording where the toggling on and off triggers display or removal from display of the respective presenter video stream, the respective screencast video stream, or the respective annotation video stream.

In a second general aspect, a system is described that include memory and at least one processor coupled to the memory where the at least one processor is configured to generate a collaborative online user interface configured to receive commands from a renderer configured to render audio and video content associated with access of a plurality of applications from within the user interface, an annotation generator tool configured to receive annotation input in the user interface and to generate, during rendering of the audio and video content, a plurality of annotation data records for the received annotation input, the annotation generator tool including at least one control to receive the annotation input, a transcription generator tool configured to transcribe the audio content during the rendering of the audio and video content, and display the transcribed audio content in the user interface, and a content generator tool configured to generate representations of the audio and video content in response to detecting termination of the rendering. The representations may be based on the annotation input, the video content, and the transcribed audio content, where the representations includes portions of the rendered audio and video marked with the annotation input.

Implementations can include any or all of the following features. In some implementations, the content generator tool is further configured to generate a URL link to the representations of the audio and video content and index the representations for enabling search functionality for finding at least a portion of the audio and video content in a web browser application. In some implementations, the plurality of annotation data records include an indication of at least one application, in the plurality of applications, receiving the annotation input, and machine-readable instructions for overlaying, according to the respective timestamp, the annotation input onto at least one image frame of a portion of the rendered video content depicting the indicated at least one application.

In some implementations, overlaying the annotation input onto the at least one image frame includes retrieving at least one of the plurality of annotation data records, executing the machine-readable instructions, and generating a document that enables a user to scroll the at least one image frame with the annotation input overlaid, according to the at least one annotation data record, onto the at least one image frame. In some implementations, the annotation generator tool is further configured to cause a recording of the rendered audio and video content to begin, the rendered video content including data associated with a first application in the plurality of applications and data associated with a second application in the plurality of applications, receive, in the first application, a first set of annotations during a first segment of the recording video content, store the first set of annotations according to respective timestamps associated with the first segment, receive in the second application, a second set of annotations during a second segment of the recording video content, and store the second set of annotations according to respective timestamps associated with the second segment.

In response to detecting that a cursor focus has switched from the first application to the second application, the annotation generator tool is further configured to retrieve the second set of annotations and the data associated with the second application, match the timestamps associated with the second segment to the second set of annotations, and cause display of the retrieved second set of annotations on the second application according to the respective timestamps associated with the second segment.

In some implementations, the first set of annotations and the second set of annotations are generated by the annotation tool, the annotation tool enabling marking, storing, and scrolling of the first set of annotations and the second set of annotations while retaining, for each annotation in the first set of annotations and the second set of annotations, an initial location on the data associated with the first application or the data associated with the second application. In some implementations, the annotation generator tool is further configured to in response to detecting that the cursor focus has switched from the second application to the first application, retrieve the first set of annotations and the data associated with the first application, match the timestamps associated with the first segment to the first set of annotations, and cause display of the retrieved first set of annotations on the first application according to the respective timestamps associated with the first segment.

In some implementations, the annotation generator tool is further configured to receive additional annotations in the second application where, the additional annotations associated with respective timestamps, and in response to detecting completion of the recording, generate a document from the second set of annotations and the additional annotations where the document includes the second set of annotations and the additional annotations overlaid onto the data associated with the second application according to the respective timestamps associated with the second segment and the respective timestamps associated with the additional annotations, and a transcription of the recorded audio content associated with the second segment.

In a third general aspect, a non-transitory computer-readable storage medium comprising instructions stored thereon that, when executed by at least one processor, are configured to cause a computing system to carry out instructions including causing a recording to begin capturing video content, the video content including a presenter video stream, a screencast video stream, a transcription video stream, and an annotation video stream and generating, based on the video content and during capture of the video content, a metadata record representing timing information used to synchronize at least one portion of the video content to input received in at least one of the presenter video stream, the screencast video stream, the transcription video stream, or the annotation video stream.

Implementations can include any or all of the following features. In some implementations, the instructions further include in response to termination of the recording, generating, based on the metadata record, a summary video of the video content, the summary video including portions of the video content annotated by a user associated with the presenter video stream.

In some implementations, the timing information corresponds to a plurality of timestamps associated with a respective input of the received input and at least one location in a document associated with the video content, and synchronizing the input includes matching, for the respective input, at least one timestamp in the plurality of timestamps, to the at least one location in the document.

In some implementations, the transcription video stream includes real-time transcribed audio data from the presenter video stream generated as textual data configured for display with the screencast video stream during the recording of the video content and real-time translated audio data from the presenter video stream generated as textual data configured for display with the screencast video stream and the transcribed audio data during the recording of the video content. In some implementations, the real-time transcribed audio data is generated as modifiable transcription data configured for display with the screencast video stream during the recording of the video content, and transcription of the real-time transcribed audio data is performed by at least one speech-to-text application, the at least one speech-to-text application selected from a plurality of speech-to-text applications determined to be accessible by the transcription video stream, and the modifiable transcription data and the textual data are stored according to timestamp in the metadata record and are configured to be searchable.

In some implementations, the input includes annotation input associated with the annotation video stream, the annotation input including video marker data and telestrator data generated by a user associated with the presenter video stream. In some implementations, the presenter video stream, the screencast video stream, the transcription video stream, and the annotation video stream are configured to be toggled on and off during the recording, the toggling on and off triggering display or removal from display of the respective presenter video stream, the respective screencast video stream, the respective transcription video stream, or the respective annotation video stream.

In a fourth general aspect, a non-transitory computer-readable storage medium comprising instructions stored thereon that, when executed by at least one processor, are configured to cause a computing system to carry out instructions that include causing a recording to begin capturing audio content and video content, the video content including at least a presenter video stream, a screencast video stream, a transcription video stream, and an annotation video stream, causing rendering of the audio content and the video content associated with access of a plurality of applications from within the user interface, receiving annotation input in the user interface during rendering of the audio content and the video content, the annotation input being recorded in the annotation video stream, transcribing the audio content during the rendering of the audio content and video content, the transcribed audio content being recorded in the transcription video stream, translating the transcribed audio content during the rendering of the audio content and video content, and causing rendering of the transcribed audio content and the translation of the transcribed audio content in the user interface with the rendered audio content and video content.

Implementations can include any or all of the following features. In some implementations, the computer-executable instructions are further configured to cause the online presentation system to generate content representative of at least a portion of the audio content and the video content, in response to detecting termination of the rendering of the video content and the audio content. The representative content may be based on the annotation input, the video content, and transcribed audio content, and the translated audio content where the representative content includes portions of the rendered audio and video marked with the annotation input. In some implementations, the annotation input is caused to be rendered as an overlay on the video content, the annotation input being configured to move with the video content in response to detecting a window event or cursor event triggering a switch to other video content accessed during the recording.

In a fifth general aspect, a computer-implemented method is described that includes receiving at least one video stream, receiving metadata representing timing information associated with input detected in the at least one video stream where the timing information is configured to synchronize the detected input provided in the at least one video stream to portions of the at least one video stream. In response to receiving a request to view the at least one video stream, the computer-implemented method may include generating portions of the at least one video stream where the generating being based on the metadata and a detected user indication requesting to view a representation of the at least one video stream and causing rendering of the portions of the at least one video stream.

Implementations can include any or all of the following features. In some implementations, the timing information corresponds to a plurality of timestamps associated with a respective input detected in the at least one video stream and at least one location in content associated with the at least one video stream, and synchronizing the detected input includes matching, for a respective input, at least one timestamp to the at least one location in a document associated with the at least one video stream. In some implementations, the at least one video stream includes a presenter video stream, a screencast video stream, a transcription video stream, and an annotation video stream. In some implementations, the representation of the at least one video stream is based on the detected input and includes the rendered portions of the at least one video stream annotated with the input.

The systems, methods, computer-readable storage medium and aspects above may be configured to perform any combination of the above-described aspects, each of which may be implemented together with any suitable combination of the above-listed features and aspects.

Implementations of the described techniques may include hardware, a method or process, or computer software on a computer-accessible medium. The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an example of a real-time presentation system, in accordance with implementations described herein.

FIGS. 2A-2B are block diagrams illustrating an example computing system configured to generate and operate the real-time online presentation system, in accordance with implementations described herein.

FIGS. 3A-3C are screenshots illustrating an example user interface (UI) of the real-time presentation system and switching between annotated content, in accordance with implementations described herein.

FIG. 4 is a screenshot illustrating an example toolbar provided by the real-time presentation system, in accordance with implementations described herein.

FIGS. 5A-5C illustrate screenshots of examples of sharing a screen in an example UI of the real-time presentation system, in accordance with implementations described herein.

FIGS. 6A and 6B illustrate screenshots of example toolbars provided by the real-time presentation system, in accordance with implementations described herein.

FIG. 7 illustrates a screenshot of example use of toolbars provided by the real-time presentation system, in accordance with implementations described herein.

FIG. 8 illustrates a flow diagram of an example of using the real-time presentation system, in accordance with implementations described herein.

FIG. 9 is a screenshot illustrating an example of a transcript generated by the real-time presentation system, in accordance with implementations described herein.

FIG. 10 is a screenshot illustrating an example of surfacing recorded content to a user of the real-time presentation system, in accordance with implementations described herein.

FIG. 11 is a screenshot illustrating another example of surfacing recorded content to a user of the real-time presentation system, in accordance with implementations described herein.

FIG. 12 is a screenshot illustrating an example of surfacing key ideas and content marked during a recording of a session generated by the real-time presentation system, in accordance with implementations described herein.

FIGS. 13A-13G illustrate screenshots depicting marked content configured by a user accessing the real-time presentation system, in accordance with implementations described herein.

FIG. 14 is a screenshot illustrating translated text shown in real time during a recording of a session generated by the real-time presentation system, in accordance with implementations described herein.

FIG. 15 illustrates a flow diagram of an example process of generating and recording a screencast, in accordance with implementations described herein.

FIG. 16 illustrates a flow diagram of an example process of generating metadata records associated with a plurality of video streams, in accordance with implementations described herein.

FIG. 17 is a flow diagram of an example process for generating and recording a video presentation in the real-time presentation system, in accordance with implementations described herein.

FIG. 18 is a flow diagram of an example process for presenting a video presentation in the real-time presentation system, in accordance with implementations described herein.

FIG. 19 shows an example of a computer device and a mobile computer device that can be used to implement the techniques described herein.

The use of similar or identical reference numbers in the various drawings is intended to indicate the presence of a similar or identical element or feature.

### DETAILED DESCRIPTION

This document describes user interfaces (UIs) and/or presentation tools to facilitate recording, sharing, viewing, interacting with, searching, and casting video content. The UIs and presentation tools may be provided in a presentation system that may be online and present content in real time. The presentation tools may be used to interact with presented (e.g., shared, casted, etc.) content. The systems and methods described herein may provide, execute, and/or control the UIs and presentation tools based on commands received from an application (e.g., a browser, a web app, an application, an extension, a native application, and the like) and/or commands received from an operating system (O/S) of a computing device. Thus, the systems and methods described herein may provide the online, real-time presentation system as an application or as an O/S-provided set of user interfaces.

In some implementations, the systems and methods described herein may be used to generate instructional content to be presented with the presentation tools. The content may be transcribed, translated, and annotated, all in real time, in order to differentiate important instructional content. The annotations may be used to generate additional related content (e.g., instructional content, study guides, representative (e.g., recap, summary, snippet) videos and related content, video snippets, screenshots, image frames, etc.). For example, the application can automatically generate recap videos based on annotations provided on content during the recording of a video (e.g., one or more presentations, classes, seminars, etc.). The annotations may be provided by a presenter and/or user. In operation, the presenter and/or user may provide input to generate annotation markings in the form of text, presenter-marked (or user-marked) importance indicators, and/or transcribed audio content markers, where the input is generated as a marker or an overlay onto content being recorded in the video.

Conventional online instructional videos may not provide a convenient way for users to find specific content within a particular video without watching and/or scanning the entire video. Once a video is recorded, conventional techniques may generate transcriptions that may be later searched, but that may not provide a real time, side-by-side view of the portion of the video pertaining to the transcribed content. A technical solution is needed to provide a live transcription and/or translation while recording a video. The systems and methods described herein provide such a technical solution which enables side-by-side a visual display of transcribed and/or translated (e.g., translation of the transcribed audio content) next to real-time annotated video content and/or screenshare/screencast content. This may provide an advantage of reinforcing learning and comprehension of the content of the video. The technical solution provided by the systems and methods described herein may enable video content (instructional content, annotations, presenter-indicated elements, transcriptions, translations, etc.) to be quickly indexed and made searchable for users. For example, the systems and methods described herein may provide a native application (or web application) configured to generate presentation (e.g., screencast) functionality with features and tools to record and interact with content being presented.

The techniques described herein provide a technical effect of enabling a single input command that simultaneously triggers the beginning of a screencast (or screenshare) presentation, a recording of the screencast, and a transcription/translation of content being screencast. Several layers of recorded content (e.g., documents, websites, nested video content layers, picture-in-picture layers, annotation layers, a presenter camera (e.g., selfie) layer, a participant (e.g., user) layer, a transcription layer, and a translation layer) may be captured separately to enable toggling the layers on and off by the presenter (i.e., the recorder) or by the user (i.e., the participant or viewer). This can provide a more flexible approach to recording, and can be more computationally efficient to record all at once than to record different layers separately, or having to post-process video to get transcription, for example. In addition, the content of a recorded screencast may be indexed to enable search tasks to retrieve and surface content while interacting with the recorded screencast or while the recorded screencast video is determined to have been recently accessed. This can provide integration of video content (not just a filename) into OS-level search functionality in an efficient manner to avoid lengthy post processing of the video. By implementing the techniques described herein at the OS-level, this approach can be more versatile than application-specific approaches to annotation as such OS-level approaches can receive and utilize signals from executing applications to adjust annotations (e.g., such as window events).

The systems and methods herein may solve the technical challenge (e.g., problem) of finding recent instructional video contents for a particular user. This can be helpful when traditional classroom/lecture based learning is replaced with home or “virtual” learning. For example, users may not know where or how to retrieve previously captured video contents when studying for an exam or performing homework tasks pertaining to instructional content taught in the video contents. Often users may have to study for an exam using a number of previously recorded videos. Conventional systems may have the user review, scan, and/or watch each video in full. However, the user may benefit from key ideas and concepts from each video. Accordingly, the systems and methods described herein provide a technical solution of automatically generated representative videos, annotated during recording of one or more original videos to indicate key ideas and concepts. For example, the systems and methods may allow for generation of one or more (e.g., a set of) curated, searchable video content (e.g., summary, snippets) deemed important by a presenter or by the user (e.g., presentation participant). The generation of these representative videos is facilitated by the stream based approach to capturing content described herein.

The systems and methods described herein provide a technical solution to the technical problem by using the underlying O/S to generate a repository of content (e.g., metadata, video content, etc.) and UIs that may be used to present the video snippets. The technical solutions described herein may provide a technical effect of improved content management, improved content access, and improved UI interactions. For example, the systems and methods described herein may generate representative videos that provide an interactive explanation of a portion of the video content, presenter comments, annotations, etc.). Moreover, these snippets may be searchable using a traditional file search or web browser application

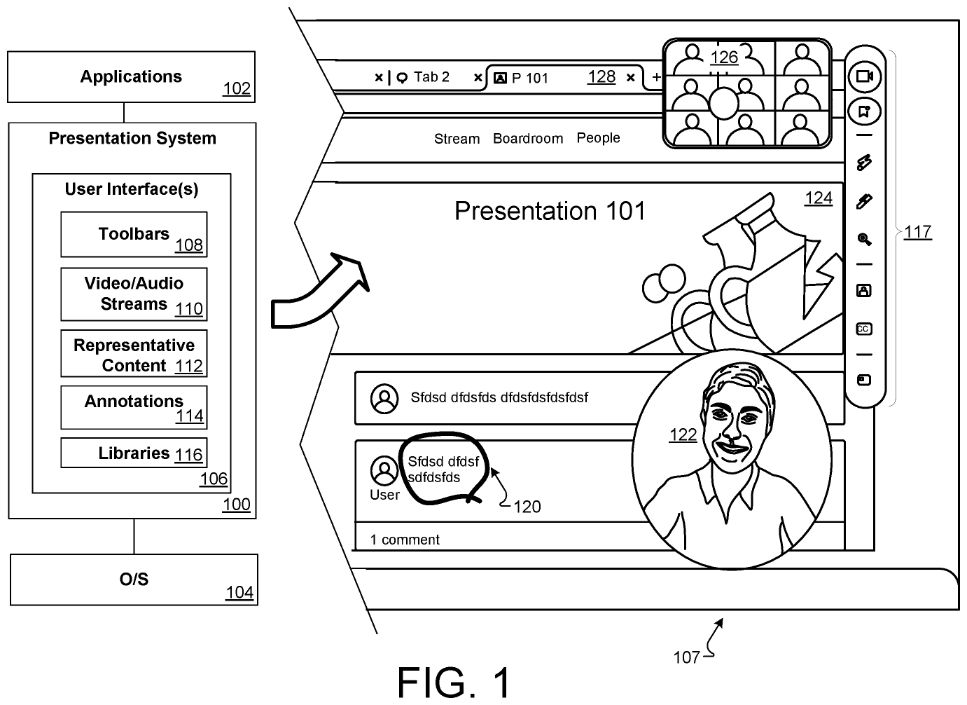

FIG. 1 is a block diagram illustrating an example of a real-time presentation system 100, in accordance with implementations described herein. The system 100 may be provided by one or more applications 102 or an operating system O/S 104. In some implementations, the system 100 may access and/or receive content from an online service, an online drive, an online library, or the like. The content may be depicted in one or more user interface(s) (UI) 106.

The real-time presentation system 100 may provide a user with controls to enable the user to make an election as to both if and when systems, operating systems, applications (e.g., programs), and/or other features described herein may enable collection of user information (e.g., information about a user's social network, social actions, or activities, profession, a user's preferences, and/or a user's current location), and if the user is sent content or communications from a server. In addition, the system 100 may ensure that certain data is treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The system 100 may generate any number of UIs (e.g., UI 107) which may be screencast, screen shared, and/or recorded and uploaded in real time or after recording to an online resource. The UIs 106 may include, present, or otherwise have access to toolbars 108, video streams and audio streams 110, representative content 112, annotations 114, and libraries 116. For example, the system 100 may be an online, real-time presentation system (e.g., application, UI, O/S-based portal) in which a user can present content using toolbars 108, annotations 114, and libraries 116. The user may also use system 100 to generate video content and audio content 110 depicting user and/or presenter provided annotations 114. The presentation content may be recorded, screencast, shared, and modified to provide particular representative content 112 which may include portions of the presentation content. In some implementations, the representative content 112 is summary content (e.g., audio and/or video content with or without annotations) that summarizes all or a portion of particular video content. In some implementations, the representative content 112 includes portions of the video and/or audio content associated with a particular topic or category. In some implementations, the representative content 112 includes video and/or audio content that includes chapter information or title information for particular videos. In some implementations, the representative content 112 includes portions of video that include markup (e.g., annotations) and such portions may include associated audio and/or metadata.

In general, the toolbars 108 may include interactive toolbars with a number of selectable tools (e.g., screencast, record screencast, presenter camera (e.g., a front-facing (i.e., selfie) camera), real time transcription, real time translation, laser pointer tools, annotation tools, magnifier tools, etc.). The toolbars may be configured for a presenter to easily present, record, cast with a single input. In addition, the toolbars may provide options to toggle the presentation, recording, and/or casting. An example toolbar is shown at toolbar 118 of FIG. 1. The toolbar 118 includes recording tools, laser pointer tools, pen tools (for generating annotations 114), eraser tools, magnifier tools, selfie camera or other capture tools, and live transcription and translation tools, and the like.

In some implementations, the toolbars 108 may include an annotation generator tool 108a configured to receive annotation input (e.g., annotation 120) in the UI 107. The annotation generator tool 108a (e.g., selected from toolbar 118) may generate, during rendering of audio and video content (and as shown in UI 107), annotation data records (e.g., records 214) for the received annotation input 120. In some implementations, the annotation generator tool 108a may include at least one control (e.g., a software or hardware based input control) to receive the annotation input 120 and to trigger storing of a timestamp for the received annotation input. For example, the system 100 may receive annotations 114 (e.g., annotation 120) and in response, may store metadata (e.g., annotation data records 214) that include one or more timestamps indicating when the input 120 was received and in which application the input 120 was received. The metadata may be later used to generate video snippets and/or representative content 112 based on when the input was received, what the input indicated, and/or an importance level of the input and/or content related to the input. In some implementations, any number of tools on toolbar 118, for example, may be part of the annotation generator tool 108a because users may select any number of tools to generate annotations on content.

In some implementations, the presentation system 100 may also generate and modify video streams and audio streams 110. For example, system 100 can be used to present content using various libraries 116 and accessed applications, images, or other resources. The content may be recorded using toolbar 118. The recorded content can be accessed by the presenter or another user. The recorded content can be used by system 100 to automatically generate representative content 112.

In some implementations, a front-facing camera tool (e.g., a selfie camera) may be included on a computing device hosting system 100. The selfie camera may be used to generate a presenter video stream, as shown by example presenter video stream 122. The consumer of content depicted in UI 107 on system 100 or the presenter (shown in stream 122) may toggle the view of the stream 122 on or off. For example, if the stream 122 overlaps content 124, for example, the presenter or consumer of content depicted in UI 107 may remove the stream 122 from view to ensure that more of the view of content 124. Similarly, a participant video stream 126 may be depicted in UI 107. The participant video stream 126 may also be toggled on or off by any of the participants or by the presenter.

In operation, the presenter (e.g., the user shown in stream 122) may access system 100 to be presented with UI 107 and toolbar 118, for example. The presenter may use toolbar 118 to cast, screencast, or otherwise share any or all of the content in UI 107 in order to present the content, annotate the content, record the content and/or annotations, upload the content and/or annotations for future review. In this example, the presenter is accessing system 100 via a browser application and has chosen to share (e.g., cast) the entire browser application including presentation 101, tab 128, stream 122, stream 126, and the previously entered annotation 120. Toolbar 118 is also presented in the shared content and may be toggled into and out of view.

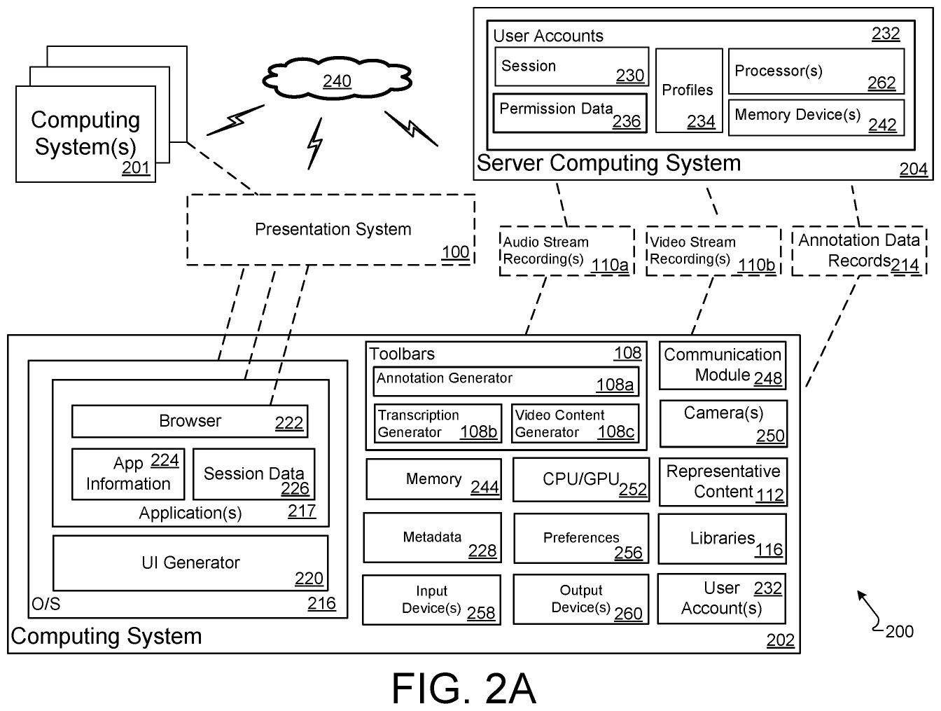

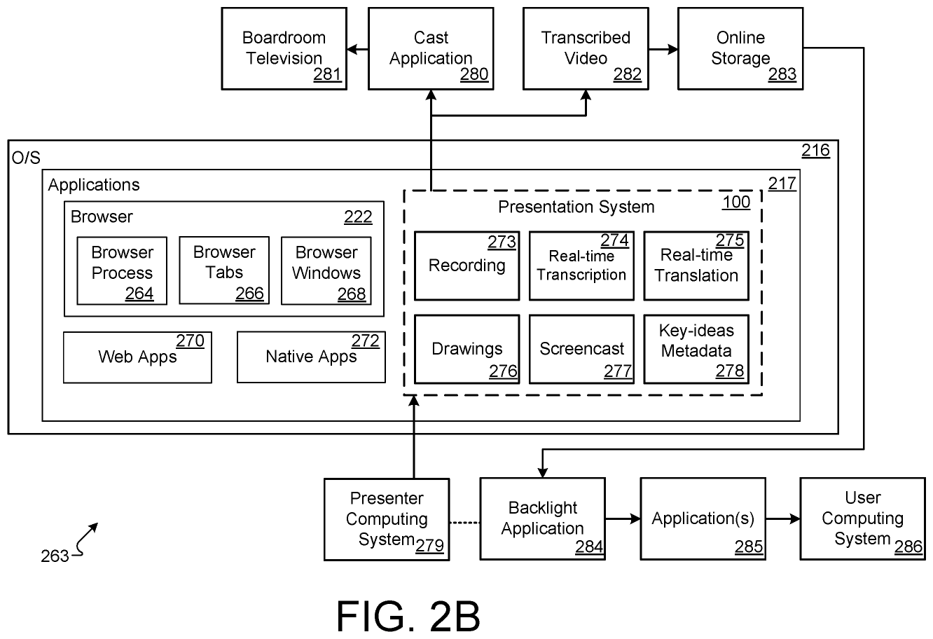

FIGS. 2A-2B are block diagrams illustrating an example computing system 200 configured to generate and operate the real-time online presentation system 100, in accordance with implementations described herein. The system 100 may operate on any of the computing systems described herein in a desktop operating system, a mobile operating system, an application extension, or other software. The system 200 may be used to configure computing devices (e.g., computing systems 201, a computing system 202 and a server computing system 204), and/or other devices (not shown in FIG. 2A) to operate the system 100 (and corresponding UIs). For example, system 200 may generate a number of UIs to allow a presenter to share, annotate, and record audio and video using the system 100.

As shown in FIG. 2A, the computing system 202 includes an operating system (O/S) 216. In general, the O/S 216 may function to execute and/or control applications, UI interactions, accessed services, and/or device communications that are not shown. For example, the O/S 216 may execute and/or otherwise manage applications 218 and UI generator 220. In some implementations, the O/S 216 may also execute and/or otherwise manage the real-time presentation system 100. In some implementations, one or more applications 218 may execute and/or otherwise manage the real-time presentation system 100. In some implementations, the browser 222 may execute and/or otherwise manage the real-time presentation system 100.

The applications 218 may be any type of computer program that can be executed/delivered by the computing system 202 (or server computing system 204 or via an external service). Applications 218 may provide a user interface (e.g., an application window, a menu, video streams, toolbars, etc.) to allow a user to interact with the functionalities of a respective application 218. The application window of a particular application 218 may display application data along with any type of controls such as menu(s), icons, toolbars, widgets, etc. The applications 218 may include or have access to app information 224 and session data 226, both of which may be used to generate content and/or data and provide such content and/or data to the users and/or the O/S 216 via a device interface. The app information 224 may correspond with information being executed or otherwise accessed by a particular application 218. For example, the app information 224 may include text, images, video content, metadata (e.g., metadata 228), control signals associated with input, output, or interaction with the application 218. In some implementations, the app information 224 may include downloaded data from a cloud server, server 204, services, or other storage resource. In some implementations, the app information 224 may include data associated with a particular application 218 including, but not limited to metadata, tags, timestamp data, URL data, and the like. In some implementations, the applications 218 may include the browser 222. The browser 222 may be utilized by system 100 to configure content for presentation, casting, and/or otherwise sharing.

The session data 226 may pertain to a user session 230 with an application 218. For example, a user may access a user account 232 via a user profile 234 on or associated with the computing system 202, or alternatively via server computing system 204. Accessing the user account 232 may include providing a username/password or other type of authentication credential and/or permission data 236. A login screen may be displayed to permit the user to supply the user credentials, which, when authenticated, allows the user to access the functionalities of the computing system 202. The session may start in response to the user account 232 being determined as accessed or when one or more user interfaces (UIs) of the computing system 202 are displayed. In some implementations, a session and a user account may be authenticated and accessed using computing system 202 without communicating with server computing system 204.

In some implementations, the user profiles 234 may include multiple profiles for a single user. For example, a user may have a business user profile and a personal user profile. Both profiles may utilize the real-time presentation system 100 in order to use and access content items stored from both user profiles. Thus, if a user has a browser session open with a professional profile and an online file or application open with a personal user profile, the system 100 may access content on both profiles.

During the session (and if authorized by the user), session data 226 is generated. The session data 226 includes information about session items used/enabled by the user during a particular computing session 230. The session items may include clipboard content, browser tabs/windows, documents, online documents, applications (e.g., web applications, native applications), virtual desks, display states (or modes) (e.g., split screen, picture-in-picture, full screen mode, selfie mode, etc.), and/or other graphical control elements (e.g., files, windows, control screens, etc.).

As the user launches, enables, and/or manipulates these session items on the user interface, session data 226 is generated. The session data 226 may include an identification of which session item (e.g., document, browser tab, etc.) has been launched, configured, or enabled. The session data 226 may also include window positions, window sizes, whether a session item is positioned in the foreground or background, whether a session item is focused or non-focused, the time in which the session items was used (or last used), and/or a recency or last appearance order of the session items, and/or metadata defining any or all of such details for the session. In some examples, the session data 226 may include recorded content for the session, such as audio stream recordings 110a and video stream recordings 110b. Such recordings may be stored on a server (such as server 204 or a cloud server), stored locally (e.g., on devices 201 or 202), or stored in a particular library 116 configured to store recorded content and metadata for the system 100.

In some examples, the session data 226 is transmitted, over a network 240, to the server computing system 204 in which the data may be stored in memory 242 in association with the user account 232 according to user permission data 236 of the user at the server computing system 204. For example, as the user launches and/or manipulates a session item on the user interface (e.g., of system 100) on the computing system 202, session data 226 about the session items may be transmitted to the server computing system 204. In some implementations, session data 226 is instead (or also) stored within a memory device 244 on computing system 202.

The UI generator 220 may generate content item and toolbar representations for rendering in UIs associated with and/or provided by system 100. The UI generator 220 may perform searches, content item analysis, browser process initiation, and other processing activities to ensure content items are accurately and efficiently rendered within a particular region or order in a UI associated with system 100. For example, the generator 220 may determine how particular content items are depicted in a UI associated with system 100. In some implementations, the generator 220 may add formatting to content items depicted by system 100. In some implementations, the generator 220 may remove formatting from content items depicted by system 100.

As shown in FIG. 2A, the O/S 216 may include or have access to services (not shown), a communication module 248, cameras 250, memory 244, and CPU/GPU 252. The computing system 202 may also include or have access to metadata 228, preferences 256. In addition, the computing system 202 may also include or have access to input devices 258, and/or output devices 260.

The services (not shown) that system 200 may have access to may include online storage, content item access, account session or profile access, permissions data access, and the like. In some implementations, the services may function to replace server computing system 204 where the user information and accounts 232 are accessed via a service. Similarly, the real-time presentation system 100 may be accessed via one or more services.

The cameras 250 may include one or more image sensors (not shown) that may detect changes in background data associated with a camera capture (and video capture) performed by computing system 202 (or another device in communication with computing system 202). The cameras 250 may include a rear-facing capture mode and a front-facing capture mode.

The computing system 202 may generate and/or distribute particular policies and permissions and preferences 256. The policies and permissions and preferences 256 may be configured by a device manufacturer of computing system 202, system 100, and/or by the user accessing system 202. Policies and preferences 256 may include routines (i.e., a set of actions) that trigger based on an audio command, a visual command, a schedule-based command, or other configurable command. For example, a user may set up a particular UI to be displayed and begin to record interactions with the UI responsive to a particular action. In response to detecting such an action, system 202 may display the UI and trigger recording. Other policies and preferences 256 may be configured to modify and or control content associated with system 202 configured with the policies and permissions and/or preferences 256.

The input devices 258 may provide data to system 202, for example, received via a touch input device that can receive tactile user inputs, a keyboard, a mouse, a hand controller, a wearable controller, a mobile device (or other portable electronic device), a microphone that can receive audible user inputs, and the like. The output devices 260 may include, for example, devices that generate content for a display for visual output, one or more speakers for audio output, and the like.

In some implementations, the computing system 202 may store particular application and/or O/S data in a repository. For example, annotations 114, data records 214, metadata 228, audio stream recordings 110a, and video stream recordings 110b may be stored for later searching and/or retrieval. Similarly, screen captures and annotation video streams may also be stored and retrieved from such a repository.

The server computing system 204 may include any number of computing devices that take the form of a number of different devices, for example a standard server, a group of such servers, or a rack server system. In some examples, the server computing system 204 may be a single system sharing components such as processors 262 and memory 242. User accounts 232 may be associated with system 204 and session 230 configurations and/or profile 234 configurations according to user permission data 236 and may be provided to system 202 at the request of a user of the user account 232, for example.

The network 240 may include the Internet and/or other types of data networks, such as a local area network (LAN), a wide area network (WAN), a cellular network, satellite network, or other types of data networks. The network 240 may also include any number of computing devices (e.g., computer, servers, routers, network switches, etc.) that are configured to receive and/or transmit data within network 240. Network 240 may further include any number of hardwired and/or wireless connections.

The server computing system 204 may include one or more processors 262 formed in a substrate, an operating system (not shown) and one or more memory devices 242. The memory devices 242 may represent any kind of (or multiple kinds of) memory (e.g., RAM, flash, cache, disk, tape, etc.). In some examples (not shown), the memory devices 242 may include external storage, e.g., memory physically remote from but accessible by the server computing system 204. The server computing system 204 may include one or more modules or engines representing specially programmed software.

In general, the computing systems 100, 201, 202, and 204 may communicate via communication module 248 and/or transfer data wirelessly via network 240, for example, amongst each other using the systems and techniques described herein. In some implementations, each system 100, 201, 202, and 204 may be configured in the system 200 to communicate with other devices associated with system 200.

FIG. 2B represents an example architecture 263 for recording video and audio and storing the resulting recorded content (e.g., audio stream recordings 110a, video stream recordings 110b, recorded annotations 114, and other recorded video streams) along with associated metadata 228. In this example, the real-time presentation system 100 is accessed via a native application for the O/S and uses recording tools associated with the native application. The recordings (e.g., video and audio streams) may be uploaded to an online drive in real time.

As shown in FIG. 2B, the O/S 216 may include or have access to real-time presentation system 100 and any number of applications 218. For example, the applications 218 may also include the browser 222. A browser 222 represents a web browser configured to access information on the Internet. The browser 222 may launch one or more browser processes 264 to generate browser content or other browser-based operations. The browser 222 may also launch browser tabs 266 in the context of one or more browser windows 268.

The applications 218 may include web applications 270. A web application 270 represents an application program that is stored on a remote server (e.g., a web server) and is delivered over the network 240 through the browser tab 266, for example. In some implementations, the web application 270 is a progressive web application, which can be saved on the device and used offline. The applications 218 may also include non-web applications, which may be programs that are at least partially stored (e.g., stored locally) on the computing system 202. In some examples, non-web applications may be executable by (or running on top of) the O/S 216.

The applications 218 may further include native applications 272. A native application 272 represents a software program that is developed for use on a particular platform or device. In some examples, the native application 272 is a software program that is developed for multiple platforms or devices. In some examples, the native application 272 is a software program developed for use on a mobile platform and also configured to execute on a desktop or laptop computer.

In some implementations, the real-time presentation system 100 may be executed as an application. In some implementations, the system 100 may be executed within a video conference application. In some implementations, the real-time presentation system 100 may be executed as a native application. In general, the system 100 can be configured to support selection, modification, and recording of audio data or text, HTML, images, objects, tables, or other content item within the applications 218.

The presentation system 100 shown in FIG. 2B includes recordings 273, real-time transcriptions 274, real-time translations 275, drawings 276, and key-ideas metadata 278. Each element 273-278 may be recorded during a session of system 100. The recorded elements 273-278 may represent video and/or audio streams which may be annotated upon by a first user (e.g., a presenter) during the session and provided (shared, cast, streamed, etc.) to any number of other users (data consumers, participants, etc.) in real time.

In some implementations, the recorded streams associated with elements 273-278 may be generated using one or more tools associated with system 100. System 100 may include and/or have access to memory and at least one processor coupled to the memory where the at least one processor is configured to generate a collaborative online user interface (e.g., system 100). The user interface being configured to receive commands from a renderer and tools/toolbars 108 (e.g., an annotation generator tool 108a, a transcription generator tool 108b, video content generator tool 108c). Each tool/toolbar 108 may be accessible via a UI or toolbar presented by system 100.

The renderer (e.g., UI generator 220) may be configured to render audio and video content associated with access of one or more of a plurality of applications from within the user interface of system 100. For example, the renderer may utilize UI generator 220 to render applications, annotations, cursors, input, video streams, or other UI content within system 100 or associated with computing system 202.

The annotation generator tool 108a (e.g., on toolbar 118) may be configured to receive annotation input (e.g., annotation input 120) in the user interface. The annotation generator tool 108a may then use that input to generate, during rendering of the audio and video content, any number of annotation data records for the received annotation input(s). The annotation generator tool 108a may include at least one control to receive the annotation input and to cause storing of a timestamp for the respective received annotation input. The timestamps may be used to match video content to annotations, transcriptions, translations, and/or other data associated with system 100.

In some implementations, the annotation data records 211 (e.g., generated from annotations 114 and/or metadata 228) may include an indication of at least one application being accessed receiving the annotation input. The annotation data records 211 may also include machine-readable instructions for overlaying (according to a respective timestamp) the annotation input onto at least one image frame of a portion of the rendered video content depicting the indicated application. For example, the annotation data records 211 may utilize any number of video streams, metadata, and annotation input to determine which particular application is receiving annotations and at what time in order to determine proper positioning of an overlay (e.g., a video stream overlay) for particular frames of one or more other video streams depicting the application, for example. These image frames and annotation overlays can be used to generate representative content 112 to allow the user to quickly review annotated concepts, which may allow the user to avoid reviewing an entire video stream.

Overlaying the annotation input onto the at least one image frame may include retrieving at least one of the plurality of annotation data records, executing the machine-readable instructions for performing the overlaying. The system 100 can then generate a document (e.g., an online document, a video snippet, a transcription snippet, an image, and the like) where the document enables a user to scroll the at least one image frame with the annotation input overlaid onto the at least one image frame (based on annotation data record(s) which indicate timestamps, annotations, etc.).

The transcription generator tool 108b may be configured to transcribe audio content captured during the rendering of the audio and video content, and may display the transcribed audio content in the user interface associated with system 100. In some implementations, the transcription generator tool 108b may also provide markers, highlights, or other indicators overlaid on the transcribed text to indicate to a user viewing the presentation, a specific location in the transcription that corresponds to the audio speech being rendered by system 100 and spoken by the presenter. In some implementations, additional indicators may be provided with or upon the transcribed text to indicate important concepts or language. A user accessing the recording at a later time can take advantage of such indicators to quickly find the important concepts or language. In addition, the system 100 may use such indicators as a trigger to obtain audio content, video content, transcription content, translation content, and/or annotation content that occurs within a threshold of time associated with the marking of a particular indicator. Such indicators may be used to generate summary content and/or other representations of the video streams (e.g., audio and video content).

For example, the summary generator tool 108c may be configured to retrieve such indicators (and/or annotations) in order to generate representative content 112, in response to detecting termination of the rendering of the audio and/or video. The representative content may be based on the annotation input, the video content, and the transcribed audio content. In some implementations, the summary content may include portions of the rendered audio and video marked with the annotation input (or other indicators). In some implementations, the video content generator tool 108c is further configured to generate a URL link to the representative content 112. For example, the system 100 may trigger particularly compiled, curated, or otherwise combined portions of video and/or audio content of one or more video streams to be uploaded to a website or online storage memory to allow the portions to be accessed conveniently and at a later time. In some implementations, the tool 108c may also index the representative content 112 for enabling search functionality for finding at least a portion of the representative content 112 using a web browser application 222, for example.

In operation, a first user (e.g., a presenter computing system 279) may trigger a session of the real-time presentation system (e.g., via an application trigger or an O/S trigger). The system may be operated by a presenter of system 279 to present and record content. For example, system 279 may trigger recordings 273 to generate video and/or audio content in the form of recorded presenter video streams (e.g., selfie camera captured content), screencast video streams (e.g., drawings 276 and screencast 277 content), annotation video streams (annotation data records 214 and/or key-idea markers and corresponding metadata 278), transcription video streams (e.g., real-time transcription 274), and/or translation video streams (e.g., real-time translation 275). The presenter may turn on/off any one of these streams during the recording. In some implementations, metadata 228 may be captured and stored during the recordings. The metadata 228 may pertain to any number of the video streams. Each video stream may also include audio data and/or annotation data. However, in some implementations, the annotation data may be separately recorded as a video layer.

Upon triggering recording and beginning to present and/or annotate content, the system 100 may trigger a cast application 280 to cast the presentation and/or annotations on separate devices (e.g., a boardroom television 281 or other device). The system 100 may also trigger transcription of the video/audio content 282, which may be generated and provided to online storage 283 in real time. The content may be formatted for presentation within system 100 in real time by a formatting application 284, which may also provide such transcribed (and/or translated data) to application 285 (or other application accessible by a user using computing system 286, for example. In some implementations, translation and transcription may not be requested by a user to be provided in a view of a UI of system 100. In that case, the presenter computing system 279 may provide recording content in real time directly to the formatting application 284 and then to the user computing system 286 (and in some examples via the application 285).

In some implementations, the system 100 may cause a recording 273 to begin capturing video content (and/or audio content). The video content (and/or audio content) may be represented as a presenter video stream, a screencast video stream, a transcription video stream, a translation video stream, an audio stream, and/or an annotation video stream. Any suitable combination of these streams may form the video content, and the streams within the video content may change if a presenter chooses to turn one or more streams off or on during the recording 273. This ability to select different streams in a simple manner provides a flexible approach to recording content and generating additional representative content from the recorded content. The system 100 may generate, based on the video content (and/or audio content) and during capture of the video content (and/or audio content), at least one metadata record. Each metadata record may represent timing information used to synchronize at least one portion of the video content to input (e.g., annotations 114/records 214, key-idea metadata 278) received in at least one of the recording video streams. In other words, the timing information can be used to synchronize input received in at least one of the presenter video stream, the screencast video stream, or the annotation video stream (or in any other stream) to the video content. The timing information may be used at a later time to generate study guides (e.g., representative content 112), overlays of annotations on snippets of video content, searchable video content, and the like.

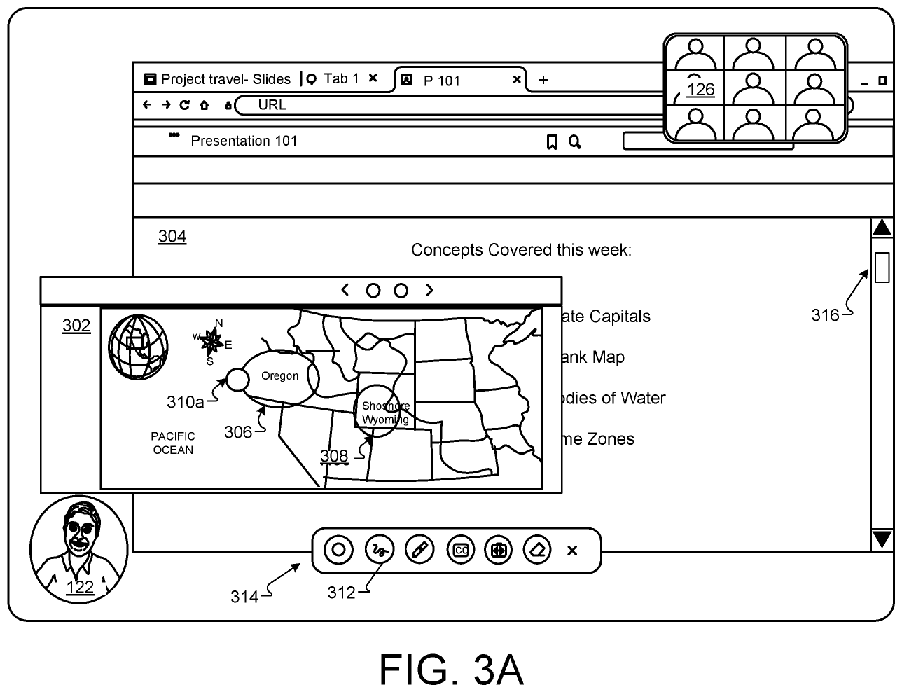

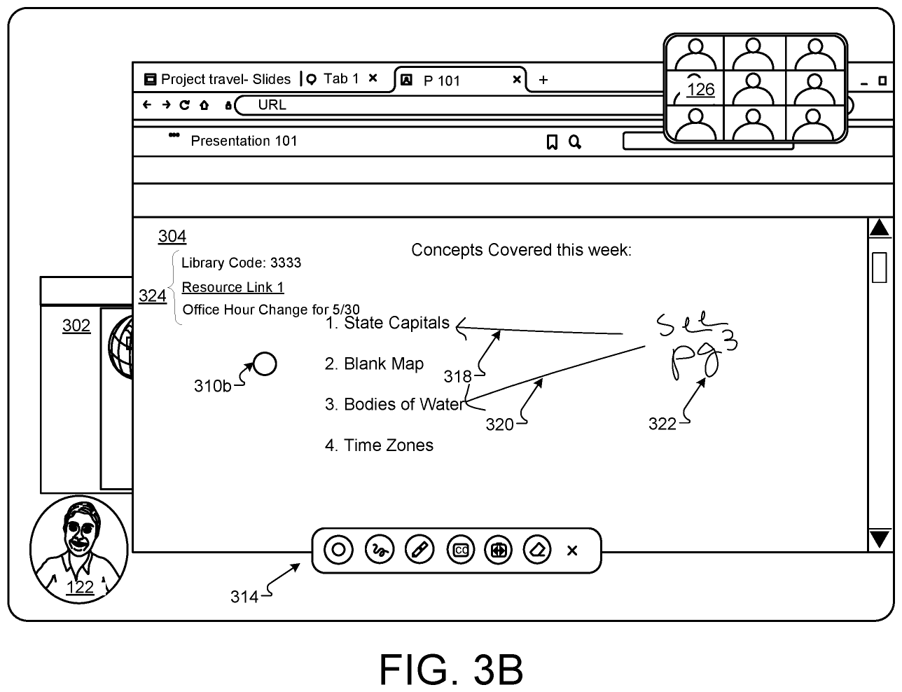

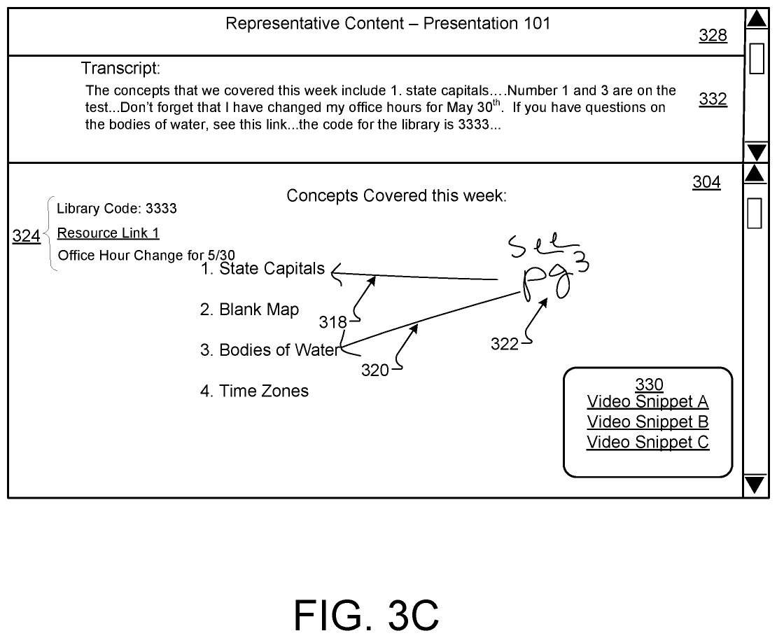

FIGS. 3A-3C are screenshots illustrating an example user interface (UI) of the real-time presentation system and switching between annotated content, in accordance with implementations described herein. In this example, a presenter (shown in presenter video stream 122) may trigger a presentation (e.g., screencast, screenshare, video conference, etc.) to begin presenting and recording content for consumption by users shown in participant stream 126. In some implementations, the system 100 is configured to trigger the beginning of a recording of particular audio and video content rendered by system 100. For example, a presenter may indicate with a single control to begin sharing content from system 100, which may trigger automatic recording of such content.

As shown in FIG. 3A, the presenter in stream 122 is presenting a first application 302 and a second application 304. The first application 302 is annotated at annotation 306 and annotation 308. The presenter in stream 122 may be actively annotating using cursor 310a using pen tool 312 from the annotator generator tool (e.g., toolbar 314), for example. In operation, the rendered video content may include data (the map and annotations 306 and 308) associated with the first application 302 from any number of open or available applications accessible to system 100. The rendered video content may also include data (e.g., geography concepts) associated with the second application 304.

Because the presenter (or consumer of the presented content) may annotate onto any number of applications, documents, content items, or display portion(s) presented by system 100, the system 100 is configured to track which of the above items receives annotations. Tracking the annotations to the annotated item may allow for the annotations to be captured as a layer of video content (e.g., a stream) such that the layer may be later overlaid or removed from view when a user accesses the recorded content at a later time. The toggling of such an overlay may ensure the user can properly view application content and annotations for the appropriate application content. In addition, the user may use a scroll control (e.g., control 316) associated with an application (e.g., application 304). The presenter may scroll content in a particular application having cursor focus to scroll the content and have the annotations scroll (e.g., move) with the content. Thus, a set of overlaid annotations may be captured and scrolled with the application content to ensure the annotated application content is preserved.

As shown in FIG. 3B, the presenter (shown in presenter stream 122) is presenting application content in application 304. In this example, the presenter used toolbar 314 to annotate the content in application 304, as shown by annotation 318, annotation 320, and annotation 322. Although annotations 318-322 are depicted as textual writing with an selected pen tool, any number of annotations and annotation types may be input using marking tools and/or selections within application content. For example, content may be highlighted, drawn on, amended, marked, etc. In some implementations, particular content may include an indicator to mark the content. For example, some content may pertain to a paragraph of text. In such examples, an entire paragraph may be marked by selecting an indicator presented on or near to the paragraph in the application content. Each annotation 318-322 may be associated with one or more timestamps representing a time in the recorded video in which the respective annotation was entered by the user. The timestamp may indicate a way for system 100 to track and search for particular content that includes annotations.

For example, tracking annotations may allow the system 100 to receive in real time, and in the first application, a first set of annotations (e.g., annotations 306 and 308) during a first segment of the recording video content and store the first set of annotations (e.g., annotations 114 and or annotation data records 214) according to respective timestamps associated with the first segment. The system 100 may also receive, in real time and in the second application (e.g., application 304), a second set of annotations (e.g., annotations 318, 320, and 322) during a second segment of the recording video content and may store the second set of annotations according to respective timestamps associated with the second segment. At some point the system 100 may detect that a cursor focus has switched between applications. For example, the system 100 may determine that the presenter has switched from using application 302 with the cursor 310a in focus to application 304 where the cursor 310b is instead, in focus. Because the annotations may be provided as a layer over the application content, the annotations may be applied and removed in response to a change in cursor focus to avoid having annotated content that no longer applies to an application or application content that has recently received cursor focus.

In response to detecting that a cursor focus has switched from the first application 302 to the second application 304, the system 100 may retrieve the second set of annotations 318, 320, and 322 and may retrieve the data associated with the second application (e.g., the application content, metadata, or other settings for the content). The system 100 may then match timestamps associated with the second segment to the second set of annotations 318, 320, and 322. In order to properly display annotations that were received at a prior timestamp, the system 100 matches the content that was in view (e.g., screencast, etc.) at the time of the timestamp and overlays the annotations (e.g., annotations 318, 320, and 322). The system 100 may then cause display of the retrieved second set of annotations (e.g., annotations 318, 320, and 322) on the second application 304 according to the respective timestamps associated with the second segment. In addition, the system 100 may remove annotations that were applied to different applications associated with system 100. For example, the system 100 may remove annotations associated with application 302 when the presenter switches cursor focus to application 304. If the user were to switch back to application 302, as shown in FIG. 3A, the system 100 may remove the annotations 318, 320, and 322 and instead retrieve and render annotations 306 and 308 to ensure that application 302 depicts accurate annotations from a previous markup, for example. In examples where applications 302, 304 are arranged side by side within the UI (i.e. not overlapping), annotations 306, 308 may be shown on application 302 and annotations 318, 320, 322 may be shown on application 304 simultaneously. In this way a user may see all the annotations at the same time for the content that is being displayed.

In some implementations, the presenter using system 100 may trigger generation of the first set of annotations (e.g., annotations 306 and 308) and the second set of annotations (e.g., annotations 318, 320, 322) via the annotation tool (e.g., from one or more tools of toolbar 314 or another toolbar). The annotation tool may enable marking, storing, and scrolling of the first set of annotations (e.g., annotations 306 and 308) and the second set of annotations (annotations 318, 320, and 322) while retaining, for each annotation in the first set of annotations and the second set of annotations, an initial location on the data associated with the first application or the data associated with the second application. That is, the annotation tool may store, for each annotation, metadata that indicates where (i.e., a location) on the data content presented by a particular application to locate the respective annotation. In this fashion, system 100 can generate an overlay of the annotations that may be restored over the data content when, for example, summary content (or other representative content) is generated. In another example, the system 100 can generate such overlays of the annotations in the proper location on the data content when the presenter scrolls the data content and/or switches between applications.

In some implementations, additional annotations (e.g., annotations 324) may be received in the second application 304. In this example, the presenter added a library code, a resource link, and a note about an office hour change. The additional annotations (e.g., annotations 324) may also be associated with respective timestamps corresponding to when during the recording the annotations 324 were added to the content in application 304. In response to detecting completion of the recording, the system 100 may generate a document 328, as shown in FIG. 3C. The document 328 may be generated from the second set of annotations (e.g., annotations 318, 320, and 322) and the additional annotations (e.g., annotations 324). The document may include the second set of annotations 318-322 and the additional annotations 324 overlaid onto the data associated with the second application 304 according to the respective timestamps associated with the second segment and the respective timestamps associated with the additional annotations. In some implementations, one or more still frames or video snippets 330 may be generated to execute within the document 328 or may be provided as links or search results associated with the document 328. The inputs (such as the annotations 318-322 and additional annotations 324) can be synchronized with the video content (i.e. overlaid at the correct location on the data from application 304) by matching the timestamp to the respective locations in the document 328 associated with the video content.

In some implementations, the system 100 may also generate a transcription 332 of the recorded audio content associated with the second segment. In general, the document 328 may be configured to be modified at any point in time. For example, the presenter may later make changes to the recorded presentation such as modified audio, additional markup or annotations, and/or other changes. Such changes may be configured to trigger the document 328 to be regenerated to include the changes. Document 328 can also be referred to as a summary content document or a representative content document.

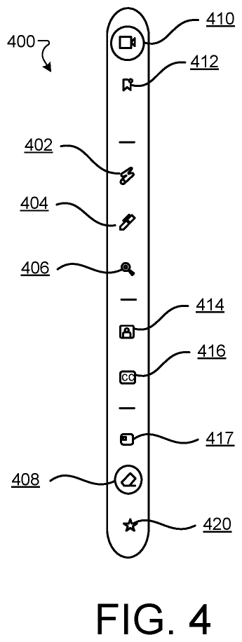

FIG. 4 is a screenshot illustrating an example presenter toolbar 400 provided by the real-time presentation system, in accordance with implementations described herein. The presenter toolbar 400 includes at least a laser pointer tool 402, a pen tool 404, a magnifier tool 406, an eraser tool 408, a record screencast tool 410, a create chapter tool 412, a selfie (e.g., presenter) camera tool 414, a closed caption tool 416, a transcription tool 418, and a marker tool 420. Each tool 402-420 in toolbar 400 may be part of the annotation generator tool 108a. For example, each tool may be used to make annotations on content being presented.

The laser pointer tool 402 may be used to configure a cursor as a laser pointer during presentation with system 100. The laser pointer tool 402 may provide visual focus for consumers of the presentation provided by system 100. The pen tool 404 may provide annotation functionality for any content or portion of a presented screen (e.g., window, application, full screen, etc.). The pen tool 404 may include any number of selectable pens, color content, size of content and/or text, shapes, etc. The magnifier tool 406 may provide zoom functionality to all small text and graphics to be magnified by the presenter during a presentation. The eraser tool 408 may provide delete and erase functionality similar to a manual eraser, to correct for errors or to remove annotations, for example, to make room to generate more annotations.

The record screencast tool 410 may provide recording functionality to begin recording and uploading such recorded content locally, to a cloud server, or other selected location. In some implementations, the record screencast tool 410 triggers screencast, screen share, or other presentation mode as well as triggering recording. For example, if the presenter selects tool 410, the presentation and the recording may begin simultaneously. This may provide an advantage of ease of presenting and recording for a user (e.g., a presenter) because the user can select a single control input to quickly begin presenting content while recording the content and/or related audio content.

In general, the screen or window to be shared upon selecting tool 410 may be a last detected share setting or a last screen used before selecting tool 410. That is, a presenter's recording scope may match a previously selected display scope (e.g., tab, window, full screen, and the like). In some implementations, a confirmation UI may be presented upon selection of tool 410 to allow the presenter to select which display scope to share and/or record. In some implementations, the presenter may stop presenting by reselecting tool 410. However, this action may not stop the recording. This may be convenient to allow the presenter to add further notes, audio, or additional content that a viewer may wish to have when accessing the recording at another time.

To terminate the recording, the presenter may select another tool or command (not shown). Terminating (e.g., stopping) a recording in system 100 may cause the toolbar 400 to be removed from view. In addition, upon detecting an indication to stop a recording, the system 100 may automatically trigger upload, sending, or otherwise finalization of the recording. Because the recording generally uploads as the recording occurs and not at completion of the recording, the delay may be minimal for upload completion. In some implementations, the system 100 may be offline and in such a situation, a local copy of the recording may instead be generated.

The create chapter tool 412 may be used by a presenter to annotate a recording video with respect to time. For example, the presenter may select tool 412 at any point during a presentation to generate a chapter for the recording video. In some implementations, the create chapter tool 412 (or a post-recording tool) may be used to create chapters for the recording after the recording is complete (e.g., post-recording). Thus, a presenter may wish to further annotate a presentation with chapters to facilitate users to search and review content from the presentation at a future time. A chapter represents a section of a video. Chapters may provide a preview image frame to assist a user with identifying chapter contents. Chapters may also include metadata, title data, or user-added or system-added identification data. A video divided with chapters may be presented in a timeline view such that users may select upon previously configured chapter indicators presented in the timeline. Conventional systems that provide chapter generation provide such a feature post-recording. That is, conventional systems do not provide an option of generating chapters in real time (e.g., on the fly) while recording a video.

The selfie (e.g., presenter) camera tool 414 may trigger functionality of a front-facing camera on a computing device (e.g., device 202) executing real-time presentation system 100. The tool 414 may be toggled between on and off by a presenter and/or a user (e.g., consumer) of the presented content. The video stream captured by tool 414 may be used by close caption tool 416 and/or transcription tool 418 to generate captions, transcriptions, and translations of audio data being presented from the video/audio stream (e.g., stream 122) captured by tool 414 (e.g., via camera 250).

The transcription tool 418 represents the transcription generator tool 108b, as described herein. Presenters of system 100 may toggle the real-time transcription of audio between on and off. In some implementations, the transcription tool 418 may trigger live transcription with full translation by using the closed caption tool 416 in combination with the transcription generator tool 108b. The transcription tool 418 may work with UI generator 220 to generate particularly formatted transcriptions for rendering alongside content presented via screen share presentation from system 100, for example.

The marker tool 420 may be selected by a presenter, for example, to mark particular content, ideas, slides, annotations, or other presented portion of a screen as a key idea. A key idea may represent elements in which the presenter deems as useful, important, study guide material and/or deems as selectable for representative content 112. If the presenter selects the marker tool 420, other indications (e.g., highlights, annotations, etc.) can be made on the presented content to be stored as a key idea in system 100. In some implementations, the marker tool 420 may provide user feedback in the form of a backlight or other indication on the tool 420 to provide an understanding to the presenter that the tool 420 is active. Other feedback options are possible.

The toolbar 400 may also include a close menu control (not shown) which may function to close or minimize the toolbar. The toolbar 400 may be moved and/or rotated for use in any presentation provided by system 100. In some implementations, the toolbar 400 may be hidden if a cursor is dragged over the toolbar, for example, when a mouseover event occurs on the toolbar. This may provide an advantage of ensuring the presenter and the viewer of the presentation (e.g., a user) may view content without having to manually move the toolbar 400.

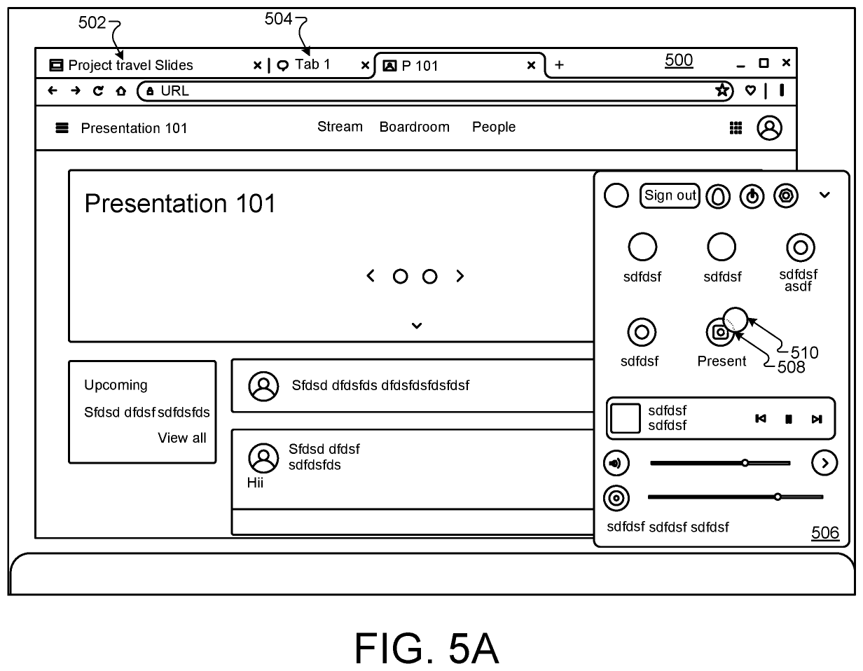

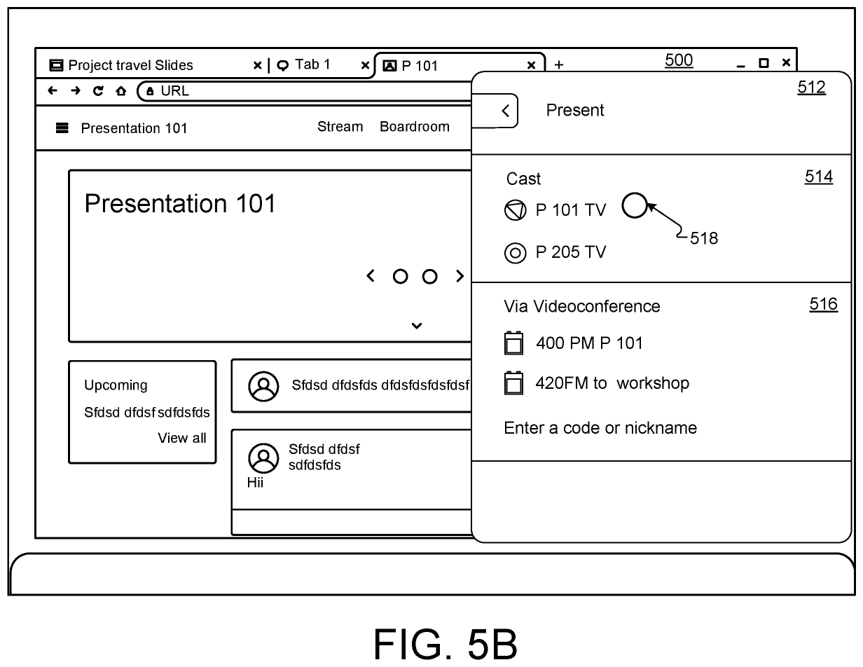

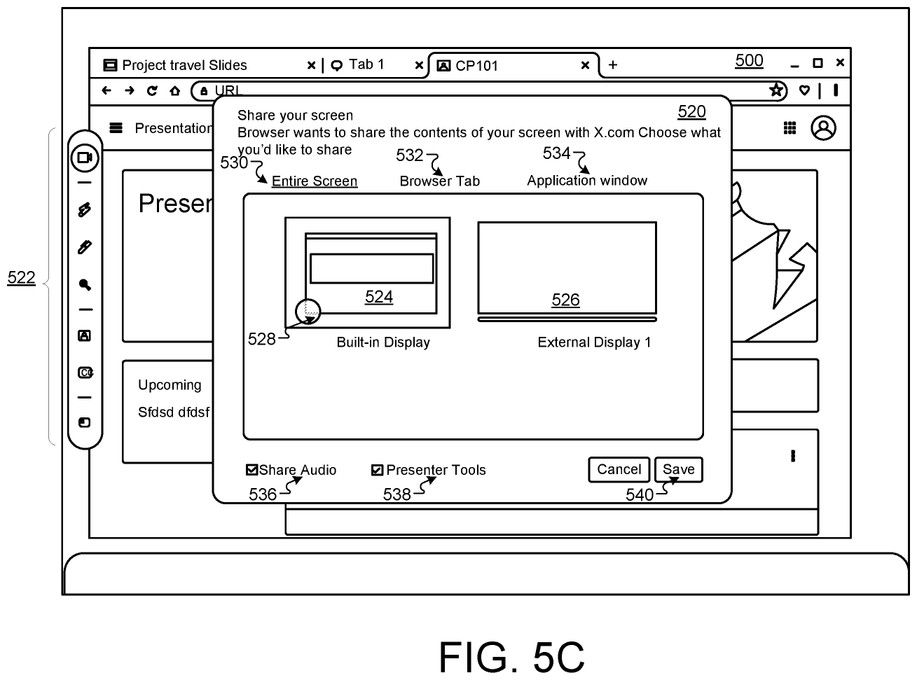

FIGS. 5A-5C illustrate screenshots of examples of sharing a screen in an example UI of the real-time presentation system, in accordance with implementations described herein. FIG. 5A depicts a browser 500 in which a user is accessing a presentation 101 (e.g., P 101) homepage. The user is also accessing content in a browser tab 502 and a browser tab 504. The user may decide to present content to one or more other users. For example, the user may be a presenter that is planning to provide a presentation to a number of users.

The presenter may access a menu UI 506 provided by computing system 202 (e.g., via O/S 216 or an application 218 hosting real-time presentation system 100). The UI 506 may be presented from a quick settings UI. From the UI 506, the presenter may select a present control 508 with cursor 510 to be provided additional screens to configure screencast and/or screen sharing for presenting content from presentation 101.

FIG. 5B depicts a present UI 512 in which the presenter may choose to cast 514 content or share content via video conference 516. For example, the presenter may choose to present the presentation 101 via screencast to a boardroom television (e.g., television 281). Alternatively, the presenter may choose to present the presentation 101 via a video conference application (e.g., by means of a native application or browser application). In this example, the presenter chose to cast the presentation 101, as shown by cursor 518.

FIG. 5C depicts a casting UI 520 in which the presenter may choose which display focus to cast. Because the user is choosing to share content, the system 100 may populate the toolbar 522 to indicate that the presentation tools are available. UI 520 includes options to share a screen. The options include at least a built-in display option 524 and an external display option 526. In this example, the presenter selected the built-in display 524, as shown by cursor 528. The presenter may also be provided options for which scope of the screen to share. Example options depicted include an entire screen option 530, a browser tab option 532, and an application window 534. Other options are possible and are based on content that is in cursor focus behind the UI 520. The presenter may be provided an option 536 to share (or not share) audio content. The presenter may also be provided an option 538 to render (or not render) presenter tools. The presenter may select options and save the selected options using save control 540.

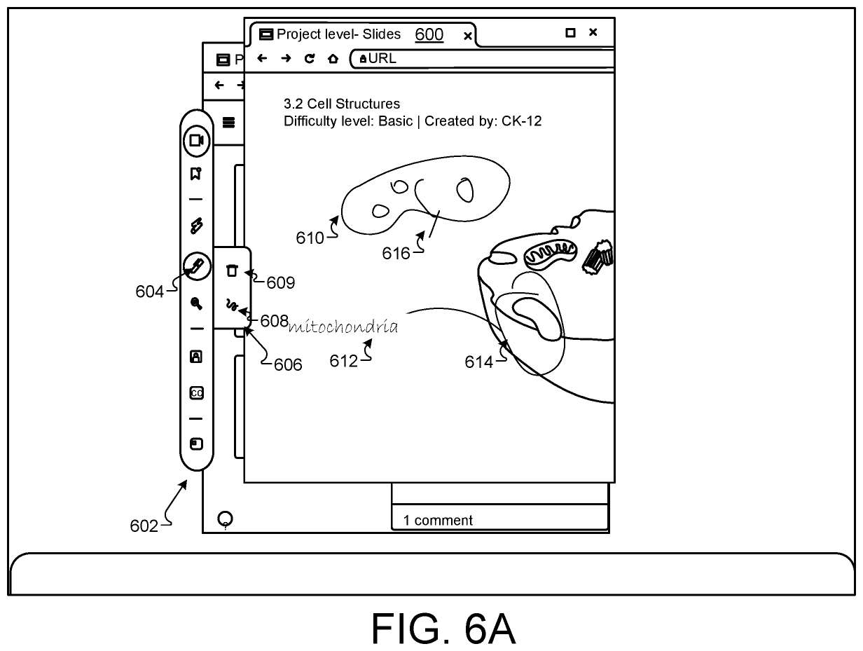

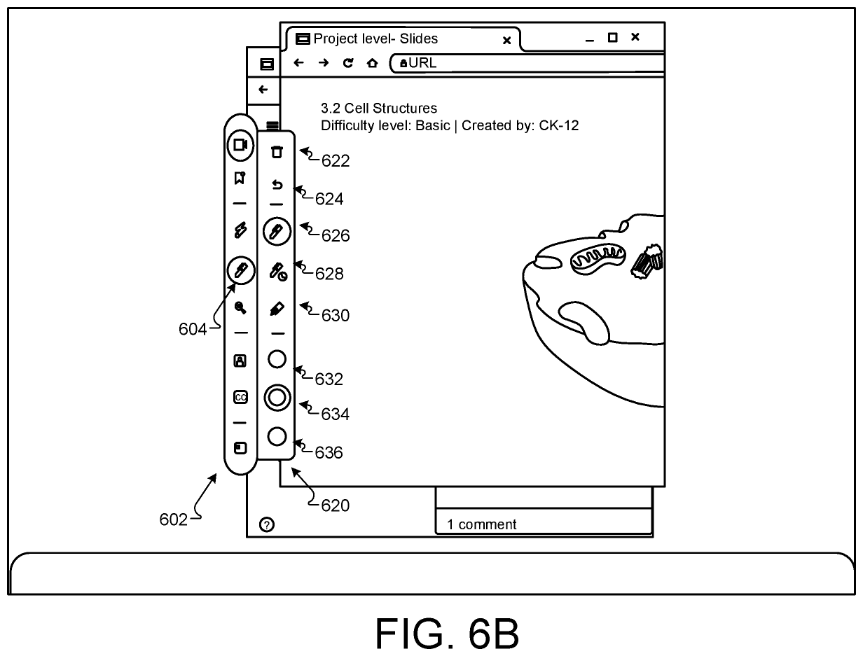

FIGS. 6A and 6B illustrate screenshots of example toolbars provided by the real-time presentation system 100, in accordance with implementations described herein. FIG. 6A depicts a shared presentation of browser tab 600 with a rendered toolbar 602. A presenter may access tools on toolbar 602, similar to toolbar 400. In this example, the presenter has selected the pen tool 604. In response, the system 100 has provided a subpanel 606 for the pen tool 604 to allow the presenter to choose options for the pen. The subpanel 606 also includes a trash option 609 to remove a selected annotation.

As shown in FIG. 6A, the presenter has provided annotation input, such as drawing 610, and text 612 and drawing (e.g., circle with line 614). The presenter has also drawn an additional marking 616, which appears to be an error or an extra pen stroke. In this case, the user may select the marking 616 and then select option 609 to remove the marking 616.

Annotations from toolbar 602 may be generated on content within a scope of the sharing window or screen. If the presenter begins to draw or annotate outside of that scope, the system 100 may trigger an indication that the annotation is out of view. In addition, annotations may be scrollable and may be configured to remain with the content annotated upon during the recording/casting session. An annotation video stream with corresponding metadata may be captured in order to match content to annotations to enable the recorded content and annotations to be accessed post-recording/casting. In some implementations, the system 100 may be configured to capture the annotations in an annotation stream, but may remove annotations from view during the recording/casting if a scroll event is detected. In some implementations, the system 100 may allow each user to manually purge annotations after recording, for example.

In some implementations, window switching may trigger annotations to be removed (e.g., hidden) when switching from one window or application to another window or application. The annotations may then be replaced (e.g., unhidden) when switching back to the window or application associated with the annotations. In addition, annotations may be resized according to a resized window. In some implementations, the annotations may remain visible (i.e., be rendered and displayed for view) as long as the underlying application content is visible to a user. In other words, the annotations may be visible even if the associated application is overlapped by another window or application, or is otherwise not in the foreground.

FIG. 6B depicts example toolbar 602 with another example subpanel 620. In this example, the toolbar 602 includes a trash option 622 to delete particular annotations, a redo/undo button to redo or undo annotation input, a static pen 626, an ephemeral pen 628, a highlighter 630, and any number of selectable colors 632, 634, and 636, just to name a few examples. Further subpanels may be provided for display to allow the presenter to select colors, fonts, line styles, or other options associated with the pen tool 604, for example.

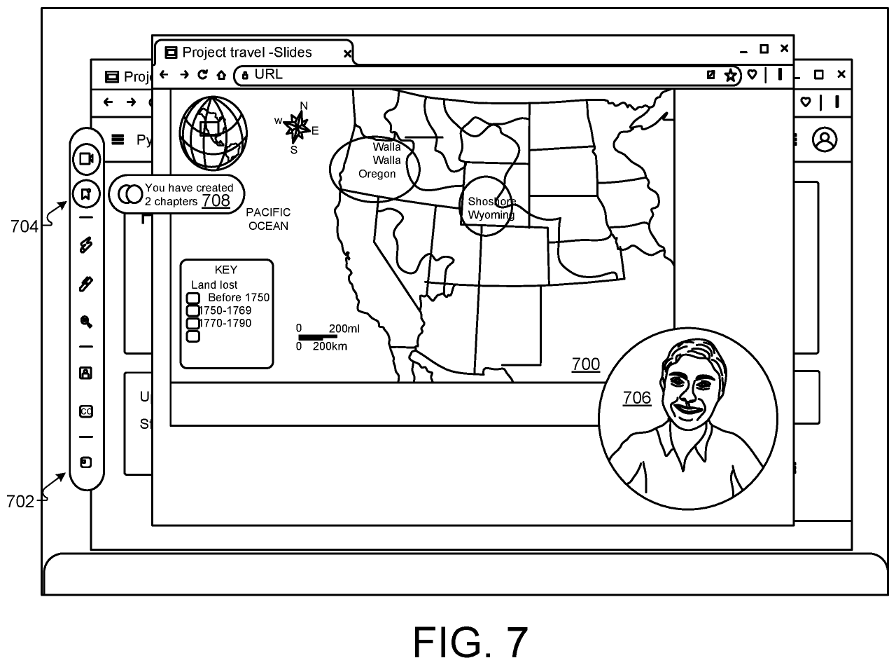

FIG. 7 illustrates a screenshot of example use of toolbars 108 provided by the real-time presentation system 100, in accordance with implementations described herein. A UI 700 depicts a partial map of the United States. A presenter may interact with the UI 700 and the depicted content of the UI 700 using a toolbar 702. In this example, the presenter selected a create chapter tool 704 during recording of the presentation to generate chapters, as indicated by indicator message 708 notifying the presenter that two chapters have been generated.

The create chapter tool 702 may be used by a presenter to annotate a recording video with respect to time. For example, the presenter may select tool 702 at any point during a presentation to generate a chapter for the recording video. A chapter represents a section of a video. Chapters may provide a preview image frame to assist a user with identifying chapter contents. Chapters may also include (or trigger storage of) metadata, title data, or user-added or system-added identification data. A video divided with chapters may be presented in a timeline view such that users may select upon previously configured chapter indicators presented in the timeline.

As shown in FIG. 7, a selfie camera stream (e.g., a presenter video stream) may be used to generate a passthrough view 706 for provision in any portion of the presentation UI space. The presenter may be a presenter or presenter of the video and audio content. The presenter video stream may be automatically located to locations on the screen throughout the recording to ensure that the stream does not block a view of content being annotated upon, for example. In some implementations, the presenter may drag the presenter video stream of view 706 within the presented UI content. In some implementations, the presenter may shrink or grow the view 706. In some implementations, the presenter may crop the view 706. In some implementations, the presenter may hide the view 706.

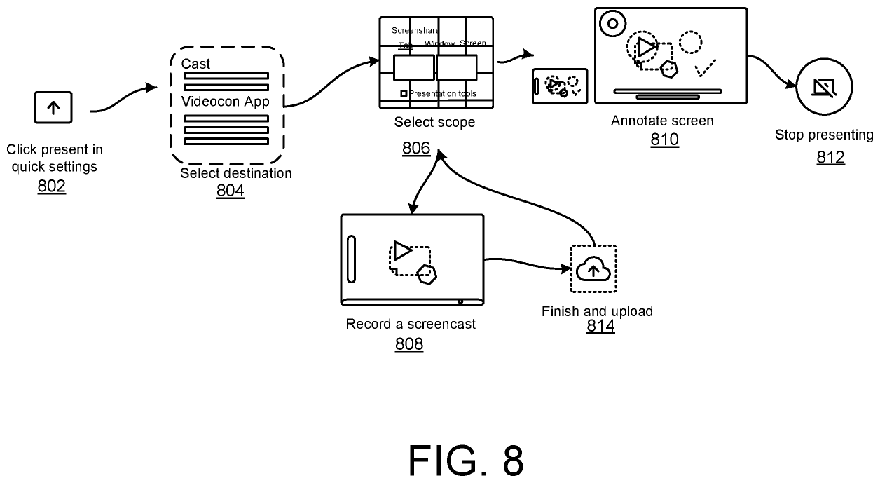

FIG. 8 illustrates a flow diagram of an example of using the real-time presentation system, in accordance with implementations described herein. In this example, a presenter may use system 100 to present ideas or content. In operation, the user may access system 100 via a quick settings UI (such as UI 506 or UI 512). The user may select (804) a destination for the presentation. For example, the user may present via cast or via video conference. The user may then select (806) a scope of a screen to share. For example, the user may choose to share one or more screens, one or more browser tabs, one or more applications, one or more windows, and the like.

In some implementations, the user may wish to record a screencast of the presentation and may do so by selecting (808) to also record the presentation. A screencast recording may then begin. In some implementations, the quick settings UI may provide an option to cast, share, and record with a single input command. The user may then perform the presentation and may generate (810) annotations, chapters, and other data. The user may select (812) to stop presenting by selecting a stop presenting control. If the user chose to record the presentation (e.g., a screencast), the user may end the presentation by stopping the recording, which may trigger (814) system 100 to finish the recording and complete an upload of the recording to a repository.

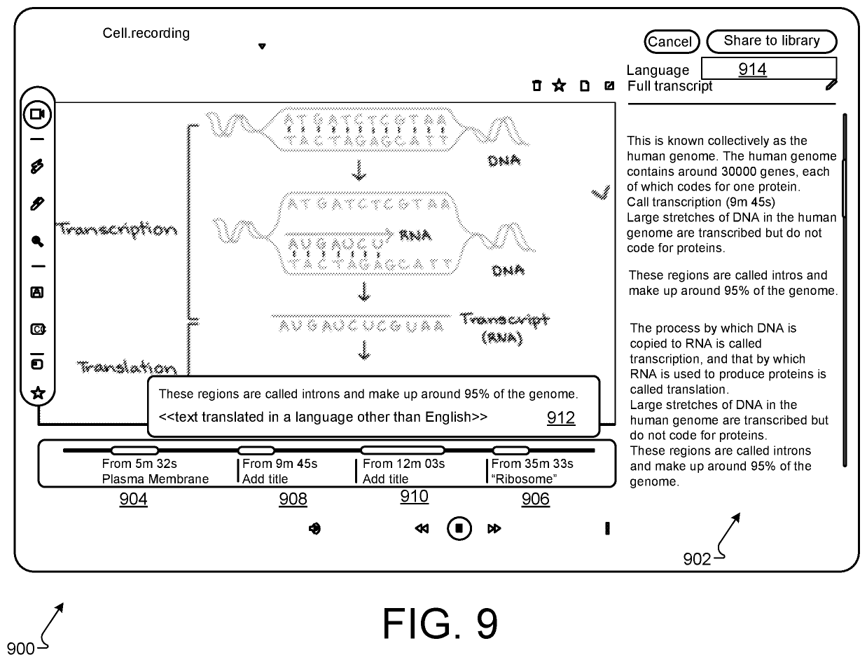

FIG. 9 is a screenshot 900 illustrating an example of a transcript 902 generated by the real-time presentation system, in accordance with implementations described herein. The view of screenshot 900 may be provided post-recording of a presentation/screencast. The system 100 may have generated the transcript 902 in real time as the recording occurred. In addition, the presenter may have made annotations to mark key idea 904 and key idea 906 during the recording. The presenter may perform post recording annotations and markup to make the video content useful to other users. For example, the presenter may decide to generate additional annotations and/or key idea markings, such as key idea 908 and key idea 910 and may do so after the recording. The new key ideas and/or annotations may be made part of a video stream that may be added to the recording data. Similarly, the presenter may add more audio data by recording additional content. The transcription 902 may be updated with the new audio data. In addition, the transcriptions 902 may be otherwise modified to add or delete content post recording.

In some implementations, the system 100 may automatically highlight particular content being accessed post recording. The highlighted content may indicate to the presenter a mistake or error of some kind. The highlight draws attention to the mistake or error so that the presenter may correct the error, for example, before disseminating additional information (e.g., representative content 112, video streams, and the like) with the recording. In some implementations, the system 100 may indicate areas in which to provide additional information. For example, the presenter may add titles, labels, etc. to key ideas.

In some implementations, system 100 may utilize machine learning techniques to learn and correct particular errors. In some implementations, the system 100 may utilize machine learning techniques to learn which content to surface to the presenter in order to provide a list of items to update and/or correct. In some implementations, the system 100 may utilize machine learning techniques to automatically generate titles and additional content from the recording to allow the presenter to pick and choose which updates to apply or add to the recording.

The presenter may also add closed captioned content and/or translated content, as shown by UI 912. In some implementations, the user may select one or more languages, using a control 914, to provide transcript content, closed captioned content, and/or translated content in as many languages as the presenter determines to provide.

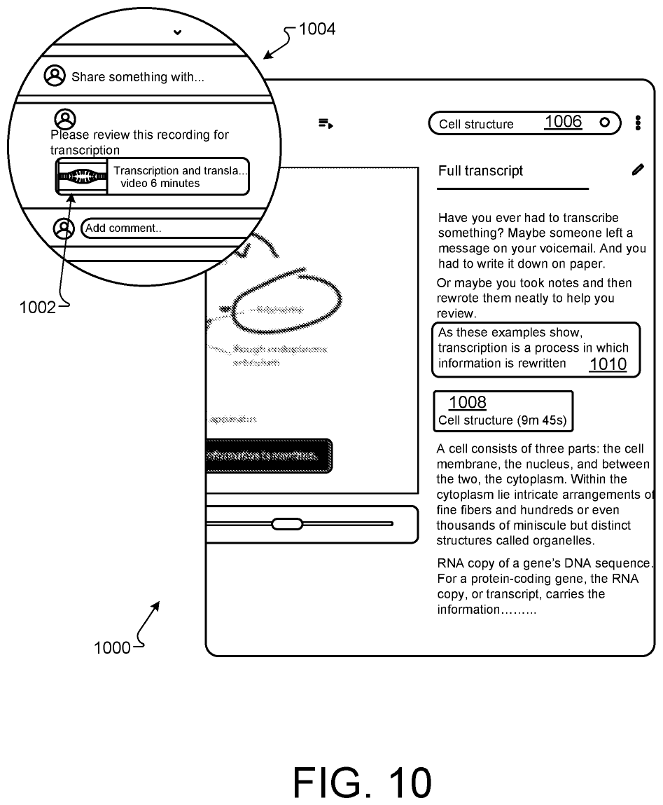

FIG. 10 is a screenshot illustrating an example of surfacing recorded content to a user of the real-time presentation system, in accordance with implementations described herein. In this example, a presenter may have completed a recording, a portion of which is shown in screenshot 1000. In response, the system 100 may analyze and index the content of the recording (e.g., any or all video streams, annotations, transcripts, translations, audio, presentation content or resources accessed during the presentation, etc.). The analysis may further include determining which content in the recording to use to generate portions of video content (e.g., representative or recap videos or snippets, study guides, audio tracks, and the like). Such content can be generated based on the metadata record and can include portions of the video content annotated by the presenter (or by a user associated with the presenter video stream). In some implementations, the summary video may also include other portions of the video content that is not annotated, but is instead selected to be included in the representative content.

As depicted in FIG. 10, the system 100 generated a video snippet 1002 discussing translation and transcription as it pertains to ribosomes in a cell. The presenter may provide an indicator, title, and or message to be surfaced with the video snippet 1002, as shown by surfaced item 1004. The item may be surfaced based on an annotation generated by the presenter. A user that receives the surfaced item 1004 may select upon links, videos or other information to obtain information surfaced by the item 1004 and/or to respond or comment about the item.

The user may also search for content in the recording, metadata, or other streams associated with the recording using control 1006. In this example, the user has entered a search query for the term ‘cell structure.’ In response, the system 100 may provide the surfaced item 1004 as a search result as well as highlighting portions of a transcription (or translation) that include the search term, as shown by highlight 1008. In addition, the system 100 may highlight additional transcription or translation content 1010 that may be related to the search query.

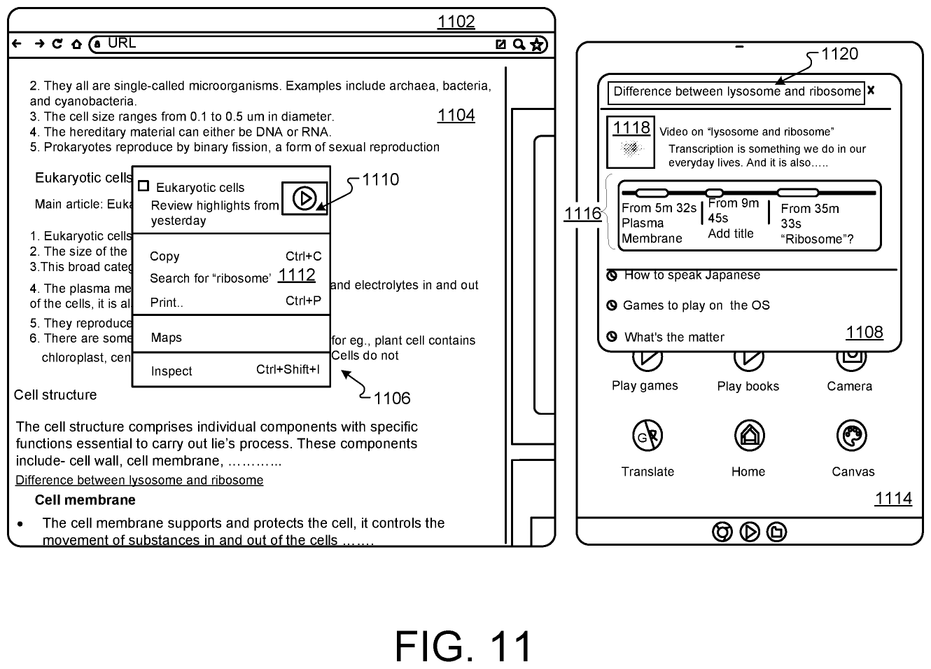

FIG. 11 is a screenshot illustrating another example of surfacing recorded content to a user of the real-time presentation system, in accordance with implementations described herein. In this example, a web browser application 1102 executing system 100, for example, depicts instructional content in window 1104. The system 100 can generate representative content 112, as shown by menu 1106 and UI 1108. The representative content of menu 1106 may include the example menu 1106 accessed by a user viewing contents in window 1104. The menu 1106 includes available video snippets 1110 related to subject matter presented in window 1104. In some implementations, the video snippets 1110 may include snippets or image frames of content presented on a specific topic or date. In some implementations, any number of video snippets and/or links may be embedded in menu 1106 to provide quick answers and content to users. Therefore, instead of surfacing results from the Internet, the system 100 can surface search results from previously accessed content accessed locally, in an online library, in an online drive, and/or from another repository. In some implementations, the system 100 may prioritize showing key idea snippets (e.g., video clips) that were recently accessed or viewed. Menu 1106 may be provided at a time that is useful to the user accessing the menu. In addition, relevant searches may be presented as options in menu 1106. For example, the user accessing menu 1106 is provided a search for the term ‘ribosome’ 1112 based on the topic being discussed in the content of window 1104.

The system 100 may surface recorded content to a user in other ways. For example, the O/S provided menu 1114 may surface additional content associated with window 1104 or with the recording(s) corresponding to the content provided in window 1104. In this example, the O/S surfaced search results in the UI 1108. In some implementations, the system 100 may surface content in a UI 1108 based on a user-entered search query 1120. For example, the entered search query 1120 may be matched to key ideas from a video recording associated with window 1104 and may be surfaced as an O/S generated search result.

As shown, the UI 1108 includes a video and a timeline 1116 of key ideas as the top search results. The user may select upon any of the events listed in the timeline 1116 to be directed, in window 1104 or a new window, to a video portion including such contents. In addition, the UI 1108 also includes one or more relevant videos 1118 to the content accessed in window 1104.

In some implementations, content surfaced in menu 1106 and/or UIs such as UI 1108 may also be retrieved from sources outside of a specific recorded video accessed in window 1104. For example, the system 100 may retrieve content for population in menu 1106 and/or UI 1108 from another presenter or another presentation similar to the presentation (or similar to content in the presentation) being accessed in window 1104. Thus, the system 100 may utilize content from other presenters, businesses, users, and/or one or more authoritative sources or resources on topics determined to be related to content accessed in window 1104.

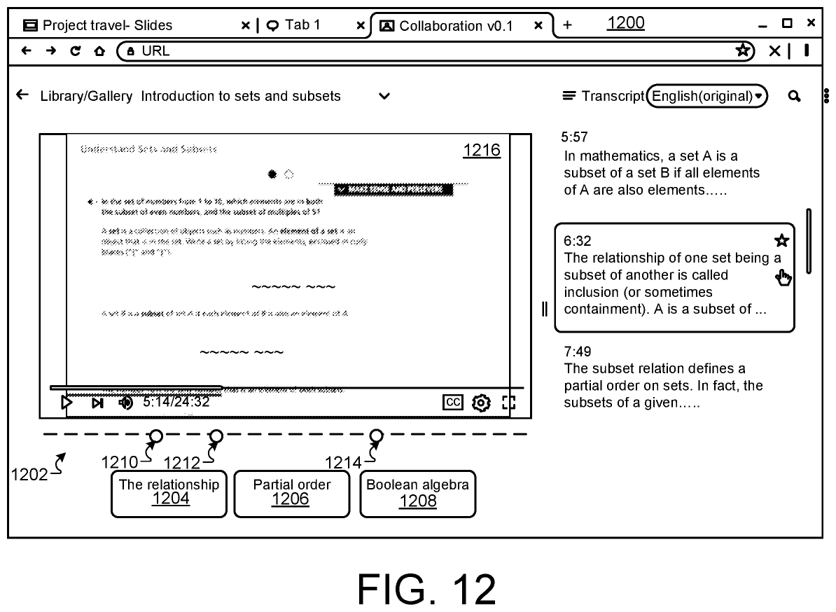

FIG. 12 is a screenshot illustrating an example of surfacing key ideas and content marked during a recording of a session generated by the real-time presentation system, in accordance with implementations described herein. In this example, the user may be using an extension, application, or O/S that provides and initiates a screencast. For example, a browser window 1200 may be shared using system 100. The shared content includes at least a timeline 1202 with key ideas 1204, 1206, and 1208, each corresponding to a respective timestamp 1210, 1212, and 1214. The timeline 1202 may be generated by a presenter of content 1216, for example, during the presentation. The presenter may alternatively generate the key ideas and timeline 1202 after completion of the video recording. It can be seen that the transcript is synchronized with the timeline 1202, such that scrolling of one of content 1216 or the transcript causes a corresponding scroll of the other.

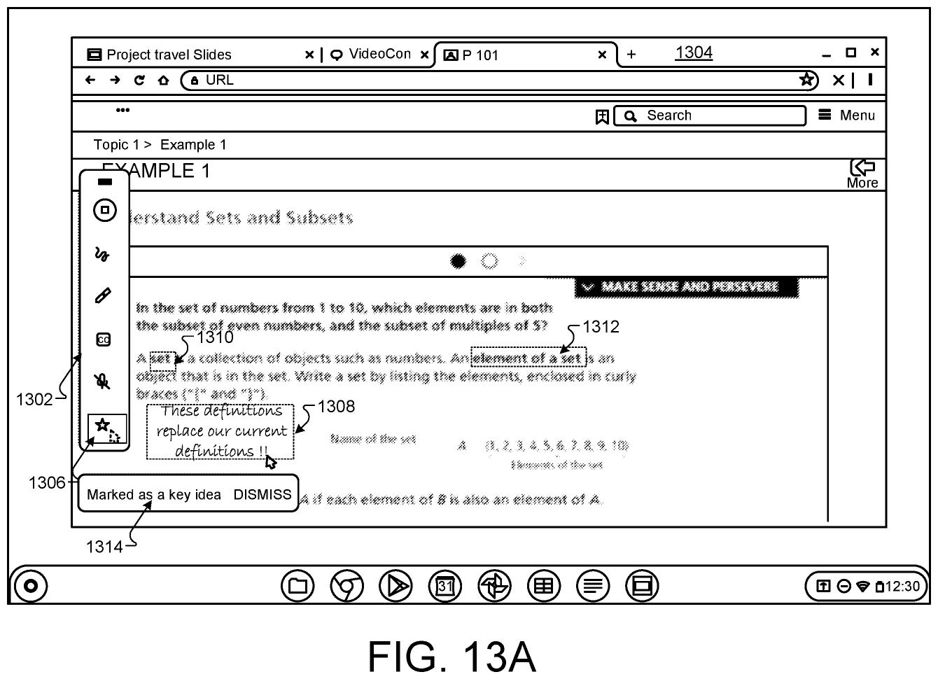

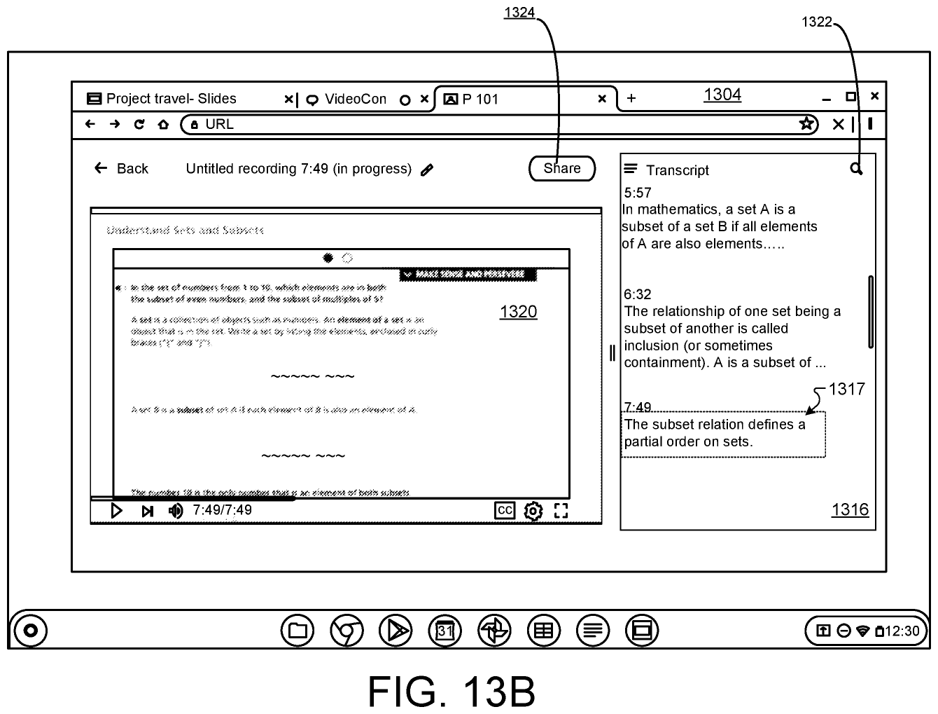

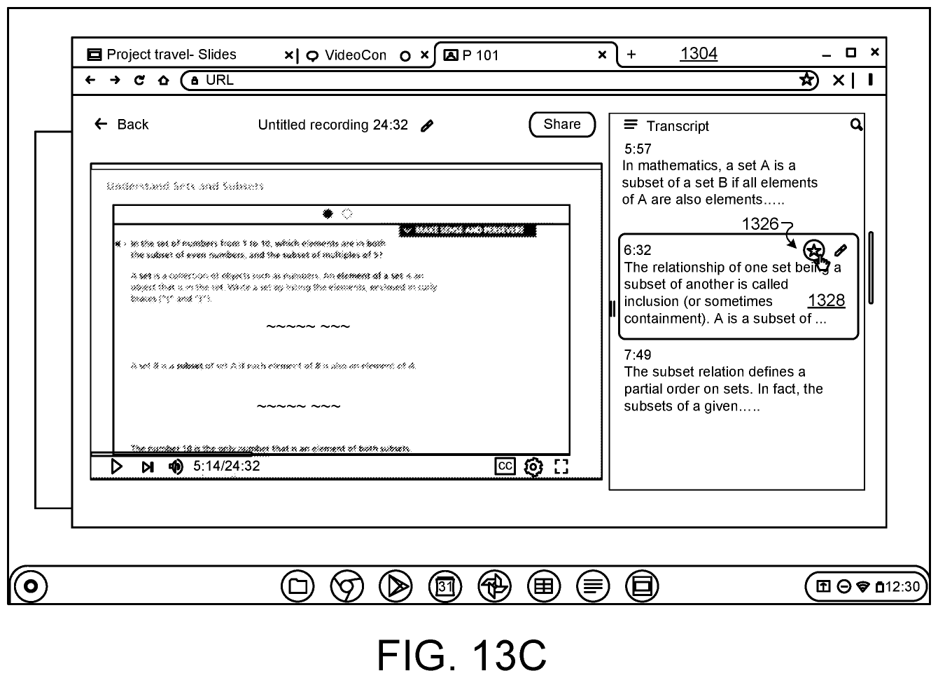

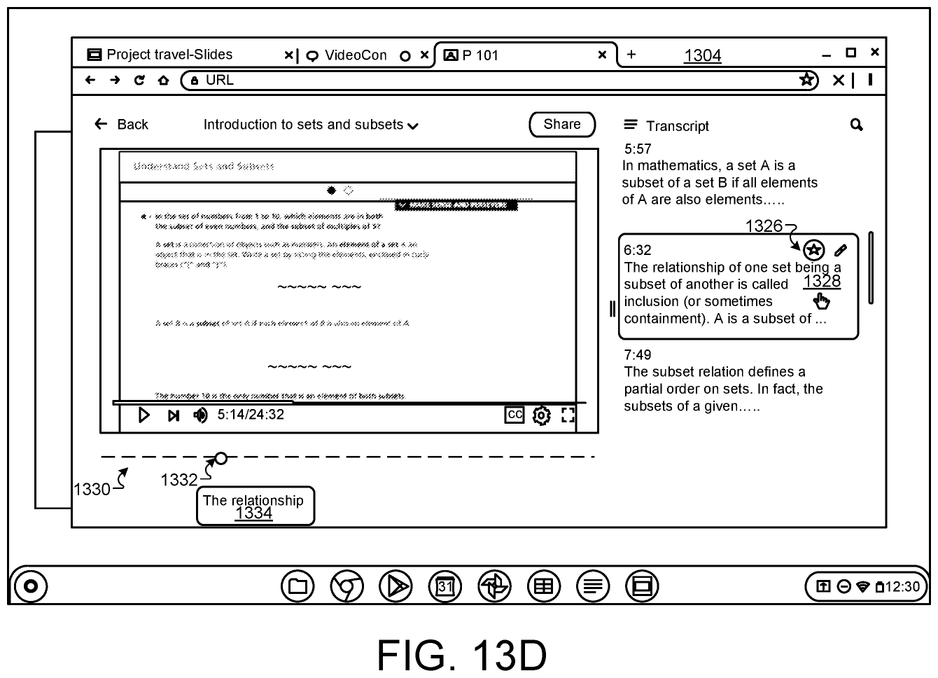

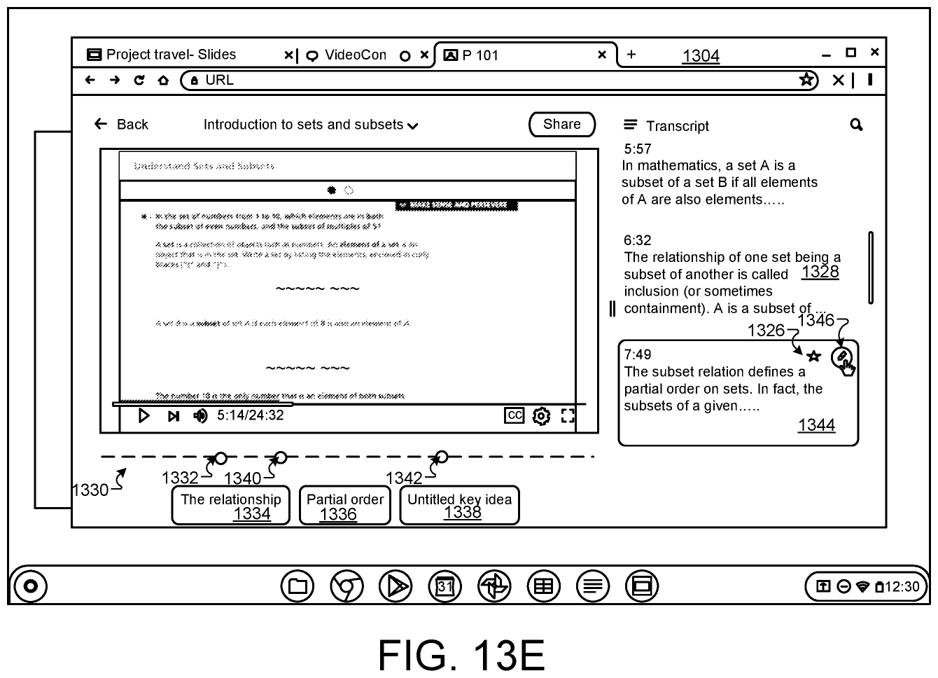

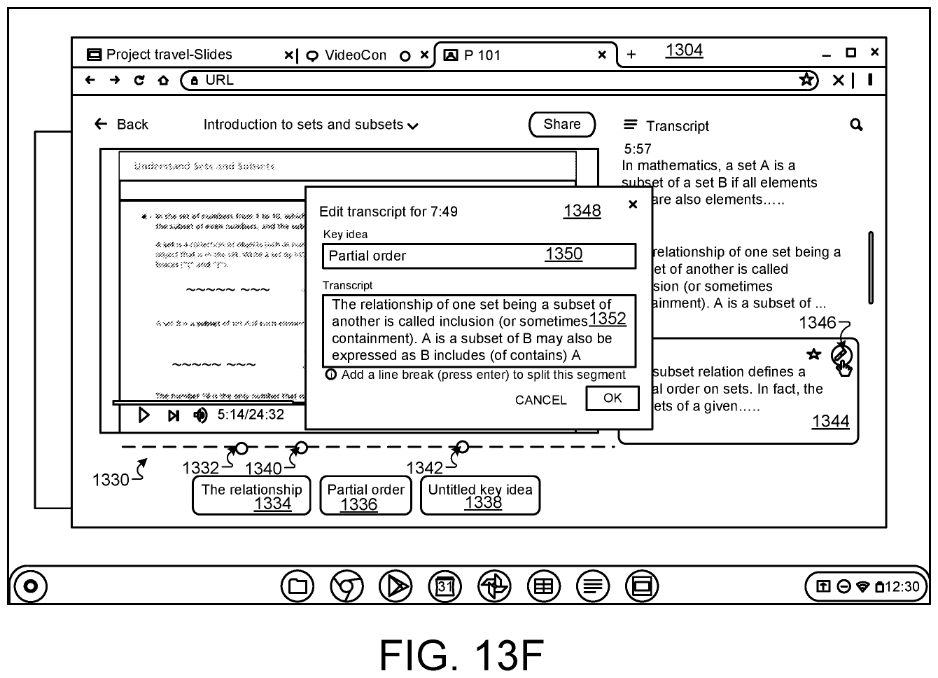

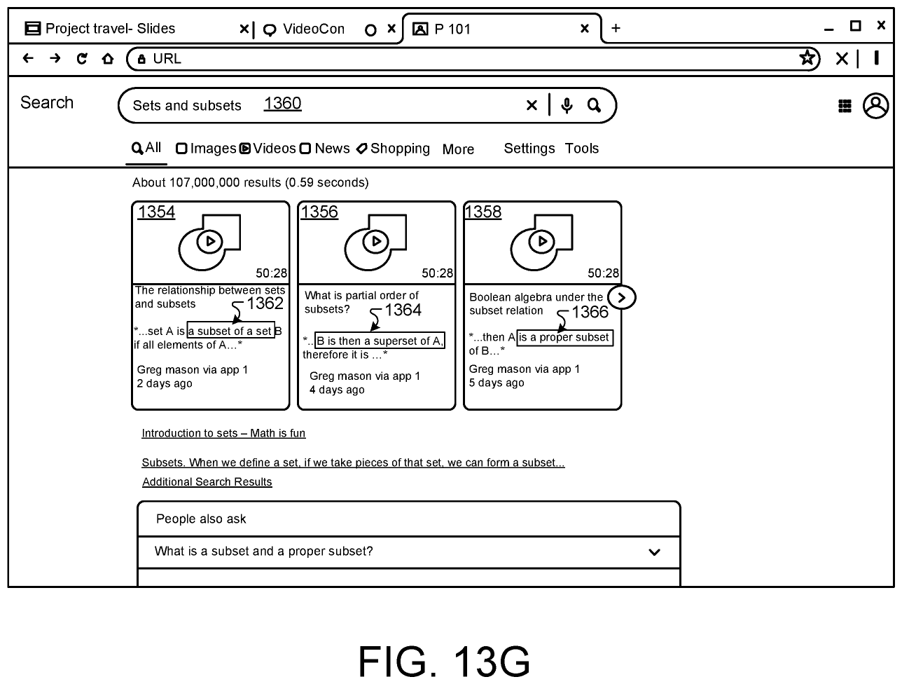

FIGS. 13A-13G illustrate screenshots depicting marked content configured by a user accessing the real-time presentation system 100, in accordance with implementations described herein. In this example, the user may be using an extension, application, or O/S that provides and initiates a screencast. A toolbar 1302 is depicted while browser window 1304 is cast by online real-time presentation system 100. The toolbar 1302 may be initiated upon beginning to cast browser window 1304, which may enable a presenter to select tools to begin telestrating (e.g., annotating on moving or still video content). In some implementations, the toolbars described herein may be bypassed, if for example, the presenter uses a stylus, a smart pen, or other such tool to provide input in the content of the presentation.

Referring to FIG. 13A, the toolbar 1302 includes a pointer tool, an ephemeral pen tool, a pen tool, a closed caption tool, a mute tool, and a key idea marker tool 1306. The marker tool 1306 may represent a control that may be selected by a presenter, for example, to mark particular content, ideas, slides, annotations, or other presented portion of a screen as a key idea. A key idea may represent elements in which the presenter deems as useful, important, study guide material and/or deems as selectable for representative content 112. In general, key ideas may be organized by dates, timestamps, and/or subjects.

In this example, the presenter has used a pen tool to enter text 1308 and/or highlights 1310 and 1312. Then, the presenter may have selected the marker tool 1306 and then marked annotations of text 1308 and highlights 1310 and 1312 to indicate such content as key ideas. In response, the system 100 may provide an indicator message 1314 to provide feedback to the presenter about the ideas being marked as key ideas. In some implementations, the marker tool 1306 may also be used to generate chapters (e.g., video markers that generate marker data, chapter markers that generate marker data, etc.) which may be provided as annotation input alongside telestrator data (i.e., highlights 1310 and 1310 and/or text 1308). The presenter may mark such annotation input with telestrations and key ideas using marker tool 1306 and/or other toolbar tools in real time and during recording. For example, while presenting, the presenter may interactively mark chapters, annotations, key ideas, and the like. The resulting annotations from the interactivity can be used by system 100 to generate study guides, representative content 112, video snippets, and searchable content to enable a user (e.g., a presentation participant) to easily access recap videos of key ideas and/or annotations.

Referring to FIG. 13B, the browser window 1304 is shown with an additional transcript section 1316. The transcript section 1316 may be generated in real time while a presenter is speaking and presenting content in window 1304 using system 100. The transcript section 1316 may represent a currently recording transcript video stream. The transcript section 1316 may highlight a current sentence being spoken, as shown by highlight 1318. In the event that a user is accessing a recorded video after completion of the recording, a current sentence being spoken may be highlighted and continue to update as the speech (e.g., audio) is provided throughout the video. This may provide an advantage of allowing the user to follow along in the transcript section 1316. As the audio progresses, the highlight updates to illustrate the particular audio being spoken.

In some implementations, a presenter or user may access the recording after completion and may navigate through the transcript to have the content in window 1320 update according to the selected transcript in section 1316. For example, a user may select a paragraph in the transcript to navigate to the beginning of the paragraph and to trigger the matching content in window 1320. In addition, the user may access a search control 1322 to search the transcript for content. The browser window 1304 also depicts a share option 1324 to allow a presenter or user to share a particular full recording, a portion of a transcript, a portion of window 1320, or other portion of the video recording.

Referring to FIG. 13C, browser window 1304 is shown and includes additional options. For example, a marker tool 1326 is provided on transcript paragraphs to enable a user to mark (or unmark) particular portions of the transcript (and resulting video portions associated with the transcript) as key ideas. For example, the user has marked a paragraph as a key idea 1328 by selecting the marker tool 1326. The user may mark or unmark paragraphs in the transcript throughout the video. The marked portions may be accessed by system 100 to generate representative content 112. Marking a transcript portion may function to automatically select related video streams at the same timestamp (or a plurality of timestamps). Thus, if a particular transcript paragraph is marked as a key idea, other content may also be marked as key ideas in or around the same timestamp. That is, marking one video stream may function to mark other video streams with key ideas including, but not limited to annotations (e.g., via the annotation video stream), translations (e.g., via the translation video stream), screen content (e.g., via the screencast video stream), camera views (e.g., via the presenter video stream), and

Referring to FIG. 13D, the browser window 1304 is again shown and the key idea marking shown in FIG. 13D is depicted in a timeline 1330 with the key idea 1328 marked at a timestamp 1332 within the video. An indicator 1334 depicts a portion of the transcript 1316. The indicator may be a video snippet or image frame to assist a user in identifying the content at the key idea timestamp 1332. In some implementations, the user may mark, unmark, or otherwise modify marked key ideas using the timeline 1330.

Referring to FIG. 13E, the browser window 1304 is again shown and additional key ideas have been marked. For example, a partial order key ideas 1336 and an untitled key idea 1338 have been marked by a user using system 100. Corresponding timestamps 1340 and 1342 have also been generated for timeline 1330. In one example, the user selected paragraph 1344 to trigger the concept 336. In addition, an edit tool 1346 may be provided when a user selects a particular translation paragraph (or other content in which the user uses to generate a key idea). The edit tool 1346 may be used to edit any transcript portion. In some implementations, the edit tool 1346 may be used to combine and/or split transcript portions, thus triggering possible changes to key ideas.

Referring to FIG. 13F, the user selected the edit tool 1346 to edit the transcript portion 1344 which may trigger an edit to key idea 1336 in timeline 1330. In response to selecting the edit tool on portion 1344, the system 100 may present UI 1348. The UI 1348 may provide entries for modifying the key idea title using a control 1350 and to modify any portion of the actual transcript, shown in a control 1352. In addition, the UI 1348 may provide controls to combine or split portions of transcripts, which may trigger combining or splitting of key ideas. Such a change to the key ideas may change the underlying video frames, text, and context of the key ideas.

Referring to FIG. 13G, a number of search results 1354, 1356, and 1358 are presented in response to a user entering a search 1360. Such search results may be generated by system 100. For example, after a presenter (or other user) generates key ideas and annotations for a video provided by system 100, the system 100 may configure the video (and underlying video streams and associated metadata) to be searchable. If a user searches (in a search engine) for content that is associated with the video, the search engine may return search results (e.g., text, video, images, and the like) that include portions of the video and/or associated content.

As shown in FIG. 13G, the search includes the search terms sets and subsets. The search results 1354-1358 may be provided because system 100 can perform or trigger indexing of portions of representative video content (e.g., key ideas, transcripts, annotations, input, etc.) to enable search functionality for finding at least a portion of the representative content using a web browser application. Particular URL links may be generated to direct a user to a portion of video or text that includes the representative content. In some implementations, video search results may be provided that may be selected to direct the user to a location (e.g., timestamp) in the video that correlates the searched term to the matching key idea. Each search result may be configured to include a video thumbnail and timestamp, a title, a transcript highlight (e.g. highlights 1362, 1364, and 1366), a user name, and an uploaded video timestamp.

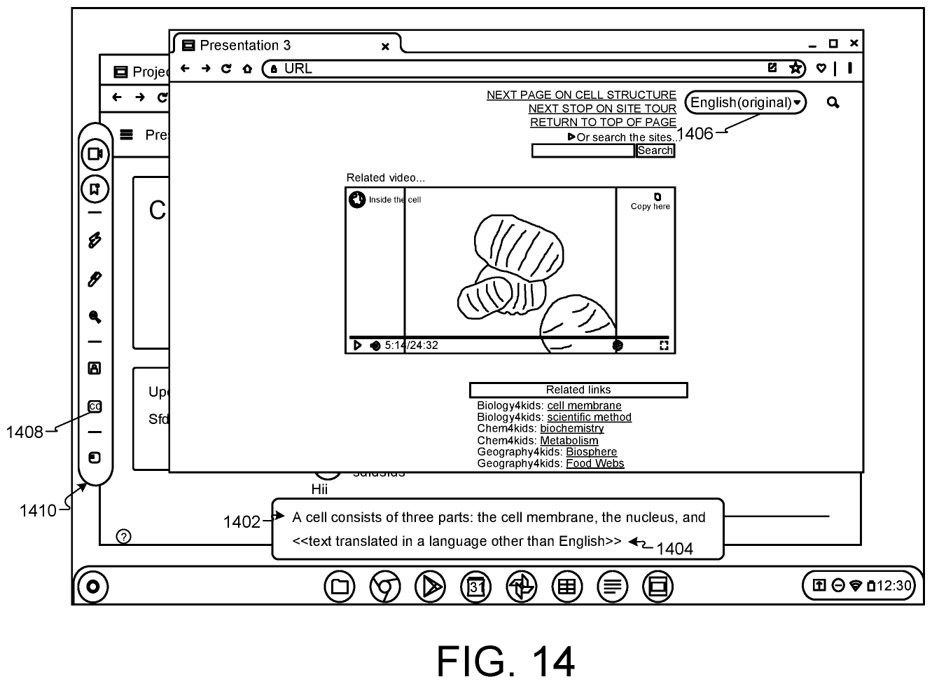

FIG. 14 is a screenshot illustrating translated text shown in real time during a recording of a session generated by the real-time presentation system 100, in accordance with implementations described herein. For example, in addition to the closed caption version 1402 of the audio being recorded and/or presented, the system 100 may also generate and render real time translations 275 shown as text 1404. A user may select which language to view particular translations using a control 1406. The translation in the selected language can form part of the transcription video stream in some examples, or may be provided as a separate translation stream.

The closed captions can be toggled on or off with tool 1408 on toolbar 1410. Providing closed caption content 1402 may make it easier for users to follow along during a presentation. Real-time translation content 1404 enables users that are learning the presenters language to follow along during a presentation. In some implementations, the user may access a previously recorded video that includes translations in a first language and may select a second language to view translations in the second language. This can help with users that are requesting help from a parent or other user that does not speak the language of the presentation.

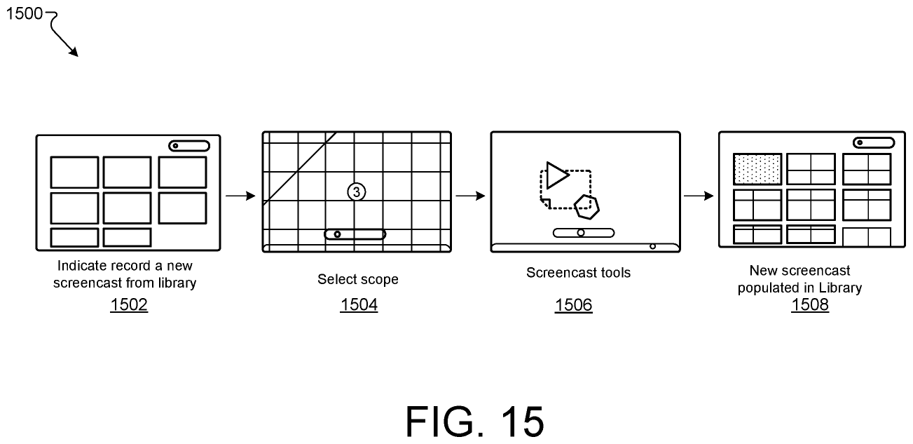

FIG. 15 illustrates a flow diagram of an example process 1500 of generating and recording a screencast, in accordance with implementations described herein. A presenter may configure computing system 202, for example, to generate a screencast beginning from one or more libraries 116 associated with real-time presentation system 100. The libraries may include content associated with the presenter that may be stored on a local storage drive, an online storage drive, server computing system 204, or another location accessible to computing system 201 and/or computing system 202. The presenter may enter a library 116 and select (1502) to begin recording a screencast. The presenter may then select (1504) a scope of content to record (e.g., a window, a tab, a full screen, etc.). The system 100 may engage a screencast/screen share tool to trigger a UI to select the scope. Although the user is recording a screencast, the user may choose not to share a screen, for example, if the screencast recording is for view by users at a later time.

Next, the system 100 may begin recording according to the selected scope and may present one or more toolbars (e.g., toolbars 108). The presenter may use (1506) screencast tools (e.g., toolbars 108) to annotate content. The presenter may choose to end the recording at some point in time. Once the recording concludes, the system 100 may automatically upload the video (and any corresponding video streams and metadata) to the library 116 as a newly available file. In some implementations, the system 100 configures the video to be viewed and shared with others.

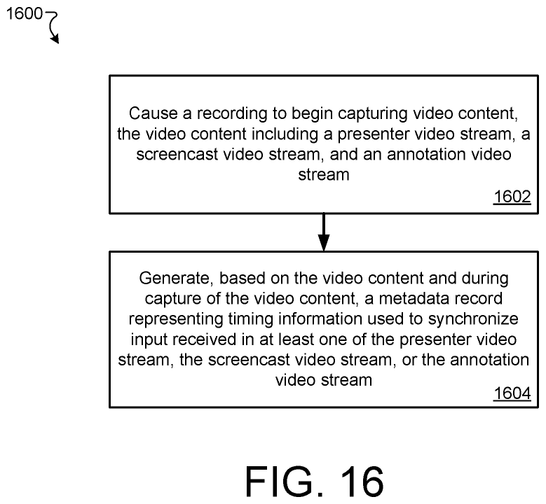

FIG. 16 illustrates a flow diagram of an example process 1600 of generating metadata records associated with a plurality of video streams, in accordance with implementations described herein. In general, process 1600 utilizes the systems and algorithms described herein to generate metadata records for use by real-time presentation system 100. The process 1600 may utilize one or more computing systems with at least one processing device and memory storing instructions that when executed cause the processing device(s) to perform the plurality of operations and computer implemented steps described in the claims. In general, system 100, system 200, system 263, and/or system 1900 may be used in the description and execution of process 1600.

At block 1602, the process 1600 includes causing a recording to begin capturing video content. The video content may include any or all of a presenter video stream, a screencast video stream, a transcription video stream, and/or an annotation video stream. For example, system 100 may be accessed by a user (e.g., a presenter) to begin a recording to capture video content. Such video content may include the presenter video stream (e.g., selfie camera captured content), the screencast video stream (e.g., drawings 276 and screencast 277 content), the annotation video streams (annotation data records 214 and/or key-idea markers and corresponding metadata 278), transcription video streams (e.g., real-time transcription 274), and/or translation video streams (e.g., real-time translation 275).

At block 1604, the process 1600 includes generating, based on the video content and during capture of the video content, a metadata record representing timing information. The timing information may be used to synchronize input received in at least one of the presenter video stream, the screencast video stream, the transcription video stream, or the annotation video stream with portion so the video content. In some implementations, the input includes annotation input associated with the annotation video stream. In some implementations, the annotations may include drawings 276, text, audio input, reference links, etc. In some implementations, the annotation input includes video marker data and/or telestrator data generated by a user associated with the presenter video stream. For example, a presenter may input annotations using a telestrator to input drawings, text, etc. as an overlay to the video content. Similarly, a presenter may use a marker tool to mark chapters during recording. The chapters may be stored as video marker data that may be used to generate chapters for video content.

In some implementations, each metadata record represents timestamp data used to synchronize input (e.g., annotations 114/records 214, key-idea metadata 278) received in at least one of the recording video streams. In some implementations, the metadata 228 may be captured and stored during the recordings. The metadata 228 may pertain to any number of the video streams and annotations received during recording of the video streams or after recording of the video streams. Each video stream may also include audio data. In some implementations, the video streams may store the annotation data as metadata. However, in some implementations, the annotation data may be separately recorded as a video layer and thus the metadata 228 may be obtained from the video layer.

In some implementations, the process 1600 includes generating, based on the metadata record, content representative of portions of video and/or audio content. For example, the representative content may include portions of the video content annotated by a user (e.g., the presenter) associated with the presenter video stream in response to termination of the recording. The video content may include representative content 112 and may be generated based on the timing information, the metadata 228, and/or other video content or annotations of video content. The generation may be automatic in response to termination of the recording, or may be initiated by a user or otherwise in response to a user input upon termination of the recording. In some implementations, the representative video content may include overlaid image frames depicting annotations on rendered video content and/or screen content. In some examples, the representative content may also include one or more portions of the video content from just before and/or just after the respective portions of the video content annotated by a user.

In some implementations, the timing information corresponds to a plurality of timestamps associated with a respective input of the received input. For example, the timing information may correspond to a received annotation (e.g., provided by the presenter) during the recording and/or screencast. The received annotation may be provided at the specific timestamp or timestamps. The timing information may also correspond to at least one location in content or a document associated with the presenter video stream, the screencast video stream, or the annotation video stream at which the input is received (or in other words, in content or a document associated with the video content). For example, the timing of creation of the annotation also corresponds to a (spatial) location within the screen/video/content in which the annotation was placed during a time period including the timestamp. In some implementations, synchronizing the input includes matching, for the respective input, at least one timestamp in the plurality of timestamps, to the at least one location in the content or a document. For example, the system 100 may perform matching processes to match annotations or marker input to locations in the video content and times associated with receiving the annotations or marker input during recording of the video content.

In some implementations, the video content further includes a transcription video stream in addition to the other plurality of video streams. The transcription video stream may include real-time transcribed audio data from the presenter video stream. The real-time transcribed audio may be generated as modifiable transcription data (e.g., textual data) configured for display with the screencast video stream during the recording of the video content. That is, the transcription may be generated and rendered in real time or near real time as the presenter records and presents content. In some implementations, the real-time translated audio data from the presenter video stream is generated as textual data configured for display with the screencast video stream and the transcribed audio data during the recording of the video content. For example, a transcription may be rendered during the recording and with the other video stream content from the screencast. In some implementations, the system 100 may also perform and render a translation of the transcription with the textual data of the transcription video stream. The textual (transcription) data may therefore be rendered with or without the translation.

In some implementations, transcription of the real-time transcribed audio data is performed by at least one speech-to-text application. At least one speech-to-text application may be selected from any number of speech-to-text applications determined to be accessible by the transcription video stream. For example, system 100 may determine which speech-to-text application may provide an accurate and convenient transcription for the audio content. Such a decision may be made based on the audio content, the language of the audio content, the demographics provided by users presenting or accessing the video streams, and the like. The modifiable transcription data and the textual data may be stored according to timestamp in the metadata record and may be configured to be searchable. This can facilitate searching of content within the video streams in an effective and resource efficient manner.

In some implementations, the presenter video stream, the screencast video stream, and the annotation video stream are configured to be toggled on and off during the recording. The toggling on and off may trigger display (or removal from display) of the respective presenter video stream, the respective screencast video stream, or the respective annotation video stream.

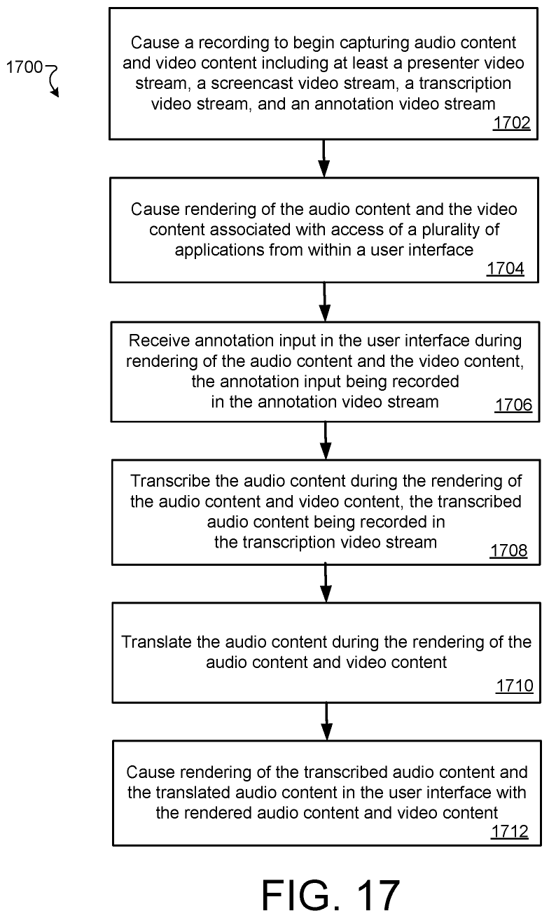

FIG. 17 is a flow diagram of an example process for generating and recording a video presentation in the real-time presentation system, in accordance with implementations described herein. In general, process 1700 utilizes the systems and algorithms described herein to generate metadata records for use by real-time presentation system 100. The process 1700 may utilize one or more computing systems with at least one processing device and memory storing instructions that when executed cause the processing device(s) to perform the plurality of operations and computer implemented steps described in the claims. In general, system 100, system 200, system 263, and/or system 1900 may be used in the description and execution of process 1700.

The real-time online presentation system 100 may be a system that includes at least one camera, at least one microphone, at least one speaker, at least one display screen, and one or more user interfaces configured to be displayed on the at least one display screen. The system 100 may carry out instructions of the process 1700 using at least one processor and one or more computer-readable hardware storage devices having stored thereon computer-executable instructions that are executable by the at least one processor.

At block 1702, the process 1700 includes causing a recording to begin capturing audio content and video content. For example, a presenter may access system 100 to trigger presentation and/or recording to begin capturing the audio content and the video content being presented, which eventually may generate recordings 110, 110b, and/or annotations 114. The video content may include at least a presenter video stream, a screencast video stream, a transcription video stream, and an annotation video stream, as described throughout this disclosure. In some implementations a metadata record may be generated based on the video content, as discussed with reference to FIG. 16.

At block 1704, the process 1700 includes causing rendering of the audio content and the video content associated with access of a plurality of applications from within the user interface. For example, during presentation and recording of the audio and video content, the system 100 may trigger content sharing (e.g., screenshare, video conference sharing, screencast, and the like). The video data may be rendered via a screen providing various UIs and the audio content may be rendered via a speaker. In some implementations, the audio content is also rendered as transcribed and/or translated text near or within a threshold distance of the remaining content being presented by system 100.

At block 1706, the process 1700 includes receiving annotation input in the user interface during rendering of the audio content and the video content. The annotation input may be recorded in the annotation video stream. For example, as a user annotates video content (e.g., annotations 306, 308 of FIG. 3A), the system 100 may record the annotations in a separate stream which may be represented as overlays that are locatable on content from other video streams captured by system 100. In some implementations, the annotation input is caused to be rendered as an overlay on the video content. The annotation input may also be configured to move with the video content in response to detecting a window event or cursor event triggering a switch to other video content (e.g., applications, windows, browser tabs, etc.) accessed during the recording. For example, a window event or other signal indicating scrolling of the window may be received, and the annotation input may be configured to scroll with the content of the underlying application such that the annotations remain at a fixed location with respect to the underlying, annotated, application content.

At block 1708, the process 1700 includes transcribing the audio content during the rendering of the audio content and video content. For example, the audio content is transcribed in real time. The transcribed audio content may be recorded in the transcription video stream and may be rendered and marked in real time by the system 100. For example, the presenter (or a user viewing the presentation) may mark, annotate, modify, or otherwise interact with transcription data that is presented in a UI provided by system 100.

At block 1710, the process 1700 optionally includes translating the audio content during the rendering of the audio content and video content. For example, the translation may be performed in real time. The translation may include translating text being presented in a screencast (or other sharing mechanism) in addition to translating audio information occurring during the presentation.

At block 1712, the process 1700 includes causing rendering, in real time, the transcribed audio content (and optionally the translated audio content) in the user interface with the rendered audio content and video content. For example, instructional/presentation content, transcribed content, and optional translated content can be depicted in a single UI such that the presenter and a user viewing the presentation have convenient access to the presented video streams in one view. In some implementations, additional video streams are added to such a view such as a presenter video stream, an annotation video stream, a participant video stream, and the like.

In some implementations, the process 1700 may also include causing the online presentation system 100 to generate summary content in response to detecting termination of the rendering of the video content and the audio content. The summary content may be representative content 112, for example, and the content 112 may be based on the annotation input, the video content, transcribed audio content, and the translated audio content (i.e. content 112 can include portions of the video content which are selected or determined based on the annotation input, transcribe audio content, etc.). The summary content may be generated based on the generated metadata record. In some implementations, the summary content includes portions of the rendered audio and video marked with the annotation input.

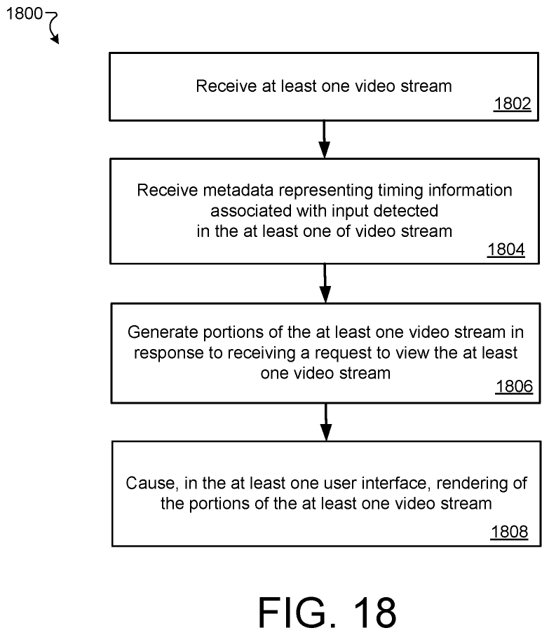

FIG. 18 is a flow diagram of an example process 1800 for presenting a video presentation in the real-time presentation system, in accordance with implementations described herein. In general, process 1800 utilizes the systems and algorithms described herein to generate metadata records for use by real-time presentation system 100. The process 1800 may utilize one or more computing systems with at least one processing device and memory storing instructions that when executed cause the processing device(s) to perform the plurality of operations and computer implemented steps described in the claims. In general, system 100, system 200, system 263, and/or system 1900 may be used in the description and execution of process 1800.

At step 1802, the process 1800 includes receiving at least one video stream. For example, a user may access system 100 to view presentation content (e.g., video and audio content). The user may select a recording to watch or may watch a recording live using system 100. In response to indicating which recording to watch, the system 100 may trigger system 202, for example, to receive one or more of a plurality of video streams. The video streams may include, but are not limited to at least the presenter video stream, a screencast video stream, a transcription video stream, and an annotation video stream, as described throughout this disclosure.

At step 1804, the process 1800 includes receiving metadata representing timing information associated with input detected in the at least one video stream. For example, the system 100 may trigger system 202 to receive metadata 228 representing the timing information. The timing information may be configured to synchronize the detected input provided in the at least one video stream to content (e.g., video, audio, data, metadata, etc.) of the at least one video stream. For example, the timing information may include information and/or instructions configured to synchronize the detected input (e.g., annotations, markers, etc.) to at least one of the plurality of video streams.

At step 1806, the process 1800 includes generating, based on the metadata, portions of the at least one video stream. The portions may be generated in response to receiving a request to view any or all of the at least one video stream. For example, a user may request to view content associated with a video stream. In response, the system 100 may generate a summary video, recap video, or other representative video (and/or audio) as a compilation or other combination of video stream portions based on the metadata.

In some implementations, the system 100 may generate and present a UI 302 with the annotations 306 and 308 retrieved from metadata to be depicted as an overlay onto content shown in UI 302. The UI 302 may be depicted with the annotations 306 and 308 overlaid onto content within UI 302 at a timestamp indicated in the metadata in response to a detected user indication requesting to view compiled content (e.g., summarized content, recap content, and/or other representative content) associated with the plurality of video streams. The generated portions may include video and/or audio content representing annotation content, video content, or other user-requested and/or system 100 provided content. In some implementations, the generated portions include content based on the detected input and includes the rendered portions of the video streams annotated with the input.

In some implementations, the entire screenshot shown in FIG. 3A may be provided as an image frame in response to detecting the request to view the compiled or otherwise curated content because the frame includes annotated content. Annotated content may be an indicator that the information in the image frame includes key data, as indicated by a presenter associated with the content of the at least one video stream.

At step 1808, the process 1800 includes causing, in the at least one user interface, rendering of the portions of the at least one video stream. For example, the UI generator 220 uses a renderer to format and display the portions indicated as compiled (e.g., recap, summarized) content. Other portions of video streams may also or alternatively be displayed responsive to a request to view compilations or other combination of content. For example, video and/or audio content may also be depicted such as video and/or audio content associated with a presenter video stream, a translation video stream, a transcription video stream, another annotation video stream, and/or other video stream generated by system 100.

In some implementations, the timing information corresponds to a plurality of timestamps associated with a respective input detected in one or more of the video streams and at least one location in content or a document associated with at least one of the one or more video streams (i.e. in content or a document associated with the at least one video stream). In some implementations, synchronizing the detected input includes matching, for a respective input, at least one timestamp to the at least one location in the document.

In some implementations, recorded videos may be opened in a native application of the device (e.g., desktop, tablet, mobile device, wearable device, etc.). The native application may provide additional tools to allow a user to read a transcript of the video recording, navigate the video recording by selecting the transcript, skip/skim between key ideas, search within and across videos, and/or watch key ideas across a range of videos (e.g. show me all the “this will be on the test” moments from a presentation preparing employees to take an exam. In some implementations, the recorded videos and system 100 may be provided as an application extension instead of a native application.

In operation of system 100, a presenter may be provided options to mark key ideas, draw over recordings in real time, and store such annotations and recordings online as any number of separate video streams in order to facilitate generating content 112 for the recordings. At the end of a recording, a presenter can review the recording and upload the recording to an online drive to share with one or more applications and/or directly with users. The system 100 enables a presenter to create a narrated screencast for users to view at a later time, record and share presentations and related content asynchronously, perform in-person presentations, and prepare for distanced presentations via video conference software and related applications.

The systems and methods described herein may provide a screenshare scope selection tool (e.g., presentation system 100). The tools of system 100 may provide an option to a user to select a presentation mode (e.g., an extended display or mirror display mode, etc.) while connecting to an external display (e.g., television or projector hardware) that also includes access to a presenter toolbar. The presenter toolbar may include a cast destination tool, a screenshare panel, a record screenshare tool, a stop screenshare tool, a telestration tool, a laser pointer tool, a closed captioning tool, a camera tool, a markup tool, as well as any number of annotation tools (e.g., pens, highlighters, shapes, and the like). The telestration tool may enable a user to telestrate anywhere on the screen. Alternatively, a stylus is directly used for annotation bypassing the presenter toolbar. The closed caption tool option provides on-device live caption and translation on top of a highlighted text, for example, with input from a microphone associated with system 100. The language of translation may be selected by a user, and may be provided in text format. In some examples, the translated text may be synthesized and output to a user as audio data.

When a user selects a record option from the presenter toolbar or the screen share panel, the current screen share scope is enabled and the tool confirms with the user whether to record and upload to a cloud server. The toolbar may provide an option for the first user to move to the screen share scope selection tool for trimming and publishing the recording when the recording is triggered via a screen capture tool. The markup option (i.e. star option in the toolbar 400) may enable the user to mark up important/key ideas presented on the screen and may display indicator texts to confirm the marking.

The toolbar may automatically transcribe captured recordings and may highlight texts for the user to check the accuracy, and may ask the user to provide a title for key ideas before uploading to a repository to share the recording with system 100 users.

The system 100 may allow for another user to search transcripts via a search bar provided when the user access the recording, navigate with the transcript and/or key ideas, or watch a recap (e.g., summary, representative portions) video of all key ideas on a predetermined time basis (e.g., daily, weekly, monthly, quarterly, yearly, and the like) since the key ideas are organized by a date and a subject. The system 100 may highlight a current sentence (being read) in the transcript and may enable the user to edit the title, transcript, and mark a paragraph key idea. The system may display recording clips as a search result or a quick answer in a browser when the user's query matches with the recorded key ideas.

In some implementations, the system 100 may provide side-by-side reading assistance UIs. For example, the system 100 may provide referencing assistance with side-by-side electronic books to preserve context for reading and referencing content while reading. Users can select any texts from within system 100 to upload the text. The system 100 can use the uploaded text to proactively suggest helpful learning moments. For example, like a glossary style related content, the system 100 may provide key concepts to surface articles and videos about the concepts. In some implementations, the system 100 may adjust the Lexile® level of particular texts. For example, the system 100 may replace particularly advanced words in texts with simpler terms to tailor content to a user with a smaller vocabulary, for example. In some implementations, the system 100 may replace particular content with less advanced content to assist the reader to understand passages of content. The system 100 may then switch to the original content to provide further understanding of vocabulary usage in the texts.

In some implementations, the system 100 may also provide in context learning moments. For example, the system 100 may build in paragraph translation for users with first learning languages that differ from the language of the text. The system 100 may also provide quick links for vocabulary look up and/or answer look up.

In some implementations, the system 100 may provide access to accessibility features such as reading aloud with speed, pitch, and accent adjustment. In some implementations, the system 100 may provide fonts to assist dyslexic readers to read passages and may also highlight sentences and/or words being read audibly by the system 100. Other highlighting, annotating, and synthesizing of data may be performed by system 100 to assist users to learn the presented concepts.

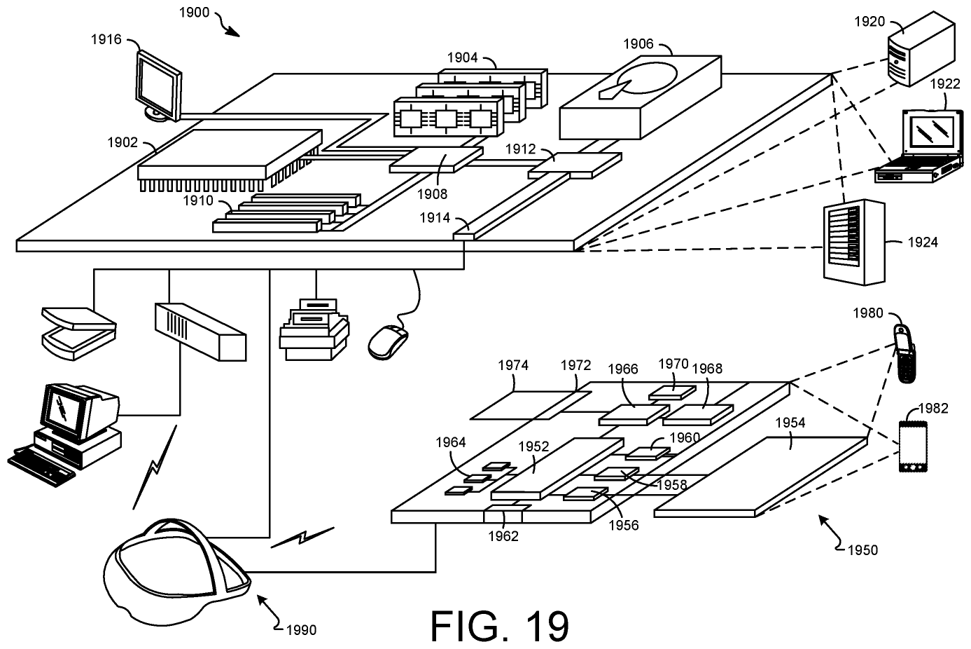

FIG. 19 shows an example of a computer device 1900 and a mobile computer device 1950, which may be used with the techniques described here. Computing device 1900 is intended to represent various forms of digital computers, such as laptops, desktops, tablets, workstations, personal digital assistants, smart devices, appliances, electronic sensor-based devices, televisions, servers, blade servers, mainframes, and other appropriate computing devices. Computing device 1950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1900 includes a processor 1902, memory 1904, a storage device 1906, a high-speed interface 1908 connecting to memory 1904 and high-speed expansion ports 1910, and a low speed interface 1912 connecting to low speed bus 1914 and storage device 1906. The processor 1902 can be a semiconductor-based processor. The memory 1904 can be a semiconductor-based memory. Each of the components 1902, 1904, 1906, 1908, 1910, and 1912, are interconnected using various busses, and may be mounted on a common motherboard or in other manners as appropriate. The processor 1902 can process instructions for execution within the computing device 1900, including instructions stored in the memory 1904 or on the storage device 1906 to display graphical information for a GUI on an external input/output device, such as display 1916 coupled to high speed interface 1908. In other implementations, multiple processors and/or multiple buses may be used, as appropriate, along with multiple memories and types of memory. Also, multiple computing devices 1900 may be connected, with each device providing portions of the necessary operations (e.g., as a server bank, a group of blade servers, or a multi-processor system).

The memory 1904 stores information within the computing device 1900. In one implementation, the memory 1904 is a volatile memory unit or units. In another implementation, the memory 1904 is a non-volatile memory unit or units. The memory 1904 may also be another form of computer-readable medium, such as a magnetic or optical disk. In general, the computer-readable medium may be a non-transitory computer-readable medium.

The storage device 1906 is capable of providing mass storage for the computing device 1900. In one implementation, the storage device 1906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods and/or computer-implemented methods, such as those described above. The information carrier is a computer- or machine-readable medium, such as the memory 1904, the storage device 1906, or memory on processor 1902.

The high speed controller 1908 manages bandwidth-intensive operations for the computing device 1900, while the low speed controller 1912 manages lower bandwidth-intensive operations. Such allocation of functions is exemplary only. In one implementation, the high-speed controller 1908 is coupled to memory 1904, display 1916 (e.g., through a graphics processor or accelerator), and to high-speed expansion ports 1910, which may accept various expansion cards (not shown). In the implementation, low-speed controller 1912 is coupled to storage device 1906 and low-speed expansion port 1914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1900 may be implemented in a number of different forms, as shown in the figure. For example, it may be implemented as a standard server 1920, or multiple times in a group of such servers. It may also be implemented as part of a rack server system 1924. In addition, it may be implemented in a computer such as a laptop computer 1922. Alternatively, components from computing device 1900 may be combined with other components in a mobile device (not shown), such as device 1950. Each of such devices may contain one or more of computing device 1900, 1950, and an entire system may be made up of multiple computing devices 1900, 1950 communicating with each other.

Computing device 1950 includes a processor 1952, memory 1964, an input/output device such as a display 1954, a communication interface 1966, and a transceiver 1968, among other components. The device 1950 may also be provided with a storage device, such as a microdrive or other device, to provide additional storage. Each of the components 1950, 1952, 1964, 1954, 1966, and 1968, are interconnected using various buses, and several of the components may be mounted on a common motherboard or in other manners as appropriate.

The processor 1952 can execute instructions within the computing device 1950, including instructions stored in the memory 1964. The processor may be implemented as a chipset of chips that include separate and multiple analog and digital processors. The processor may provide, for example, for coordination of the other components of the device 1950, such as control of user interfaces, applications run by device 1950, and wireless communication by device 1950.

Processor 1952 may communicate with a user through control interface 1958 and display interface 1956 coupled to a display 1954. The display 1954 may be, for example, a TFT LCD (Thin-Film-Transistor Liquid Crystal Display) or an OLED (Organic Light Emitting Diode) display, or other appropriate display technology. The display interface 1956 may comprise appropriate circuitry for driving the display 1954 to present graphical and other information to a user. The control interface 1958 may receive commands from a user and convert them for submission to the processor 1952. In addition, an external interface 1962 may be provided in communication with processor 1952, so as to enable near area communication of device 1950 with other devices. External interface 1962 may provide, for example, for wired communication in some implementations, or for wireless communication in other implementations, and multiple interfaces may also be used.

The memory 1964 stores information within the computing device 1950. The memory 1964 can be implemented as one or more of a computer-readable medium or media, a volatile memory unit or units, or a non-volatile memory unit or units. Expansion memory 1974 may also be provided and connected to device 1950 through expansion interface 1972, which may include, for example, a SIMM (Single In Line Memory Module) card interface. Such expansion memory 1974 may provide extra storage space for device 1950, or may also store applications or other information for device 1950. Specifically, expansion memory 1974 may include instructions to carry out or supplement the processes described above, and may include secure information also. Thus, for example, expansion memory 1974 may be provided as a security module for device 1950, and may be programmed with instructions that permit secure use of device 1950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1964, expansion memory 1974, or memory on processor 1952, that may be received, for example, over transceiver 1968 or external interface 1962.

Device 1950 may communicate wirelessly through communication interface 1966, which may include digital signal processing circuitry where necessary. Communication interface 1966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1968. In addition, short-range communication may occur, such as using a Bluetooth, Wi-Fi, or other such transceiver (not shown). In addition, GPS (Global Positioning System) receiver module 1970 may provide additional navigation- and location-related wireless data to device 1950, which may be used as appropriate by applications running on device 1950.

Device 1950 may also communicate audibly using audio codec 1960, which may receive spoken information from a user and convert it to usable digital information. Audio codec 1960 may likewise generate audible sound for a user, such as through a speaker, e.g., in a handset of device 1950. Such sound may include sound from voice telephone calls, may include recorded sound (e.g., voice messages, music files, etc.) and may also include sound generated by applications operating on device 1950.

The computing device 1950 may be implemented in a number of different forms, as shown in the figure. For example, it may be implemented as a cellular telephone 1980. It may also be implemented as part of a smart phone 1982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some embodiments, the computing devices depicted in FIG. 19 can include sensors that interface with a virtual reality or headset (VR headset/AR headset/HMD device 1990). For example, one or more sensors included on computing device 1950 or other computing device depicted in FIG. 19, can provide input to AR/VR headset 1990 or in general, provide input to an AR/VR space. The sensors can include, but are not limited to, a touchscreen, accelerometers, gyroscopes, pressure sensors, biometric sensors, temperature sensors, humidity sensors, and ambient light sensors. Computing device 1950 can use the sensors to determine an absolute position and/or a detected rotation of the computing device in the AR/VR space that can then be used as input to the AR/VR space. For example, computing device 1950 may be incorporated into the AR/VR space as a virtual object, such as a controller, a laser pointer, a keyboard, a weapon, etc. Positioning of the computing device/virtual object by the user when incorporated into the AR/VR space can allow the user to position the computing device to view the virtual object in certain manners in the AR/VR space.

In some embodiments, one or more input devices included on, or connect to, the computing device 1950 can be used as input to the AR/VR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 1950 when the computing device is incorporated into the AR/VR space can cause a particular action to occur in the AR/VR space.

In some embodiments, one or more output devices included on the computing device 1950 can provide output and/or feedback to a user of the AR/VR headset 1990 in the AR/VR space. The output and feedback can be visual, tactical, or audio. The output and/or feedback can include, but is not limited to, rendering the AR/VR space or the virtual environment, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some embodiments, computing device 1950 can be placed within AR/VR headset 1990 to create an AR/VR system. AR/VR headset 1990 can include one or more positioning elements that allow for the placement of computing device 1950, such as smart phone 1982, in the appropriate position within AR/VR headset 1990. In such embodiments, the display of smart phone 1982 can render stereoscopic images representing the AR/VR space or virtual environment.

In some embodiments, the computing device 1950 may appear as another object in a computer-generated, 3D environment. Interactions by the user with the computing device 1950 (e.g., rotating, shaking, touching a touchscreen, swiping a finger across a touch screen) can be interpreted as interactions with the object in the AR/VR space. As an example, computing device can be a laser pointer. In such an example, computing device 1950 appears as a virtual laser pointer in the computer-generated, 3D environment. As the user manipulates computing device 1950, the user in the AR/VR space sees movement of the laser pointer. The user receives feedback from interactions with the computing device 1950 in the AR/VR environment on the computing device 1950 or on the AR/VR headset 1990.

In some embodiments, a computing device 1950 may include a touchscreen. For example, a user can interact with the touchscreen in a particular manner that can mimic what happens on the touchscreen with what happens in the AR/VR space. For example, a user may use a pinching-type motion to zoom content displayed on the touchscreen. This pinching-type motion on the touchscreen can cause information provided in the AR/VR space to be zoomed. In another example, the computing device may be rendered as a virtual book in a computer-generated, 3D environment. In the AR/VR space, the pages of the book can be displayed in the AR/VR space and the swiping of a finger of the user across the touchscreen can be interpreted as turning/flipping a page of the virtual book. As each page is turned/flipped, in addition to seeing the page contents change, the user may be provided with audio feedback, such as the sound of the turning of a page in a book.

In some embodiments, one or more input devices in addition to the computing device (e.g., a mouse, a keyboard) can be rendered in a computer-generated, 3D environment. The rendered input devices (e.g., the rendered mouse, the rendered keyboard) can be used as rendered in the AR/VR space to control objects in the AR/VR space.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A computer-implemented method comprising:
causing a recording to begin capturing video content, the video content including a presenter video stream, a screencast video stream, and an annotation video stream; and
generating, based on the video content and during capture of the video content, a metadata record representing timing information used to synchronize at least one portion of the video content to input received in at least one of the presenter video stream, the screencast video stream, or the annotation video stream.

2. The computer-implemented method of claim 1, further comprising:
in response to termination of the recording, generating, based on the metadata record, a representation of the video content, the representation including portions of the video content annotated by a user associated with the presenter video stream.

3. The computer-implemented method of claim 1, wherein:
the timing information corresponds to a plurality of timestamps associated with a respective input of the received input and at least one location in a document associated with the video content; and
synchronizing the input includes matching, for the respective input, at least one timestamp in the plurality of timestamps, to the at least one location in the document.

4. The computer-implemented method of claim 1, wherein the video content further includes a transcription video stream, the transcription video stream including:
real-time transcribed audio data from the presenter video stream generated as modifiable transcription data configured for display with the screencast video stream during the recording of the video content; and
real-time translated audio data from the presenter video stream generated as textual data configured for display with the screencast video stream and the transcribed audio data during the recording of the video content.

5. The computer-implemented method of claim 4, wherein:
transcription of the real-time transcribed audio data is performed by at least one speech-to-text application, the at least one speech-to-text application selected from a plurality of speech-to-text applications determined to be accessible by the transcription video stream; and
the modifiable transcription data and the textual data are stored according to timestamp in the metadata record and are configured to be searchable.

6. The computer-implemented method of claim 1, wherein the input includes annotation input associated with the annotation video stream, the annotation input including video marker data and telestrator data generated by a user associated with the presenter video stream.

7. The computer-implemented method of claim 1, wherein the presenter video stream, the screencast video stream, and the annotation video stream are configured to be toggled on and off during the recording, the toggling on and off triggering display or removal from display of the respective presenter video stream, the respective screencast video stream, or the respective annotation video stream.

8. A system comprising:
memory; and
at least one processor coupled to the memory, the at least one processor being configured to generate a collaborative online user interface, the user interface being configured to receive commands from:
a renderer configured to render audio and video content associated with access of a plurality of applications from within the user interface;
an annotation generator tool configured to receive annotation input in the user interface and to generate, during rendering of the audio and video content, a plurality of annotation data records for the received annotation input, the annotation generator tool including at least one control to receive the annotation input;
a transcription generator tool configured to transcribe the audio content during the rendering of the audio and video content, and display the transcribed audio content in the user interface; and
a content generator tool configured to generate representations of the audio and video content in response to detecting termination of the rendering, the representations being based on the annotation input, the video content, and the transcribed audio content, wherein the representations include portions of the rendered audio and video marked with the annotation input.

9. The system of claim 8, wherein the content generator tool is further configured to:
generate a URL link to the representations of the audio and video content; and
index the representations for enabling search functionality for finding at least a portion of the audio and video content in a web browser application.

10. The system of claim 8, wherein the plurality of annotation data records include:
an indication of at least one application, in the plurality of applications, receiving the annotation input; and
machine-readable instructions for overlaying, according to the respective timestamp, the annotation input onto at least one image frame of a portion of the rendered video content depicting the indicated at least one application.

11. The system of claim 10, wherein overlaying the annotation input onto the at least one image frame includes:
retrieving at least one of the plurality of annotation data records,
executing the machine-readable instructions; and
generating a document that enables a user to scroll the at least one image frame with the annotation input overlaid, according to the at least one annotation data record, onto the at least one image frame.

12. The system of claim 8, wherein the annotation generator tool is further configured to:
cause a recording of the rendered audio and video content to begin, the rendered video content including data associated with a first application in the plurality of applications and data associated with a second application in the plurality of applications;
receive, in the first application, a first set of annotations during a first segment of the recording video content;
store the first set of annotations according to respective timestamps associated with the first segment;
receive in the second application, a second set of annotations during a second segment of the recording video content;
store the second set of annotations according to respective timestamps associated with the second segment;
in response to detecting that a cursor focus has switched from the first application to the second application,
retrieve the second set of annotations and the data associated with the second application;
match the timestamps associated with the second segment to the second set of annotations; and
cause display of the retrieved second set of annotations on the second application according to the respective timestamps associated with the second segment.

13. The system of claim 12, wherein the first set of annotations and the second set of annotations are generated by the annotation tool, the annotation tool enabling marking, storing, and scrolling of the first set of annotations and the second set of annotations while retaining, for each annotation in the first set of annotations and the second set of annotations, an initial location on the data associated with the first application or the data associated with the second application.

14. The system of claim 12, wherein the annotation generator tool is further configured to:
in response to detecting that the cursor focus has switched from the second application to the first application,
retrieve the first set of annotations and the data associated with the first application;
match the timestamps associated with the first segment to the first set of annotations; and
cause display of the retrieved first set of annotations on the first application according to the respective timestamps associated with the first segment.

15. The system of claim 12, wherein the annotation generator tool is further configured to:
receive additional annotations in the second application, the additional annotations associated with respective timestamps; and
in response to detecting completion of the recording, generate a document from the second set of annotations and the additional annotations, the document including:
the second set of annotations and the additional annotations overlaid onto the data associated with the second application according to the respective timestamps associated with the second segment and the respective timestamps associated with the additional annotations; and
a transcription of the recorded audio content associated with the second segment.

16. A non-transitory computer-readable storage medium comprising instructions stored thereon that, when executed by at least one processor, are configured to cause a computing system to carry out instructions including:
causing a recording to begin capturing video content, the video content including a presenter video stream, a screencast video stream, a transcription video stream, and an annotation video stream; and
generating, based on the video content and during capture of the video content, a metadata record representing timing information used to synchronize at least one portion of the video content to input received in at least one of the presenter video stream, the screencast video stream, the transcription video stream, or the annotation video stream.

17. The non-transitory computer-readable storage medium of claim 16, wherein the instructions further include:
in response to termination of the recording, generating, based on the metadata record, a representation of the video content, the representation including portions of the video content annotated by a user associated with the presenter video stream.

18. The non-transitory computer-readable storage medium of claim 16, wherein:
the timing information corresponds to a plurality of timestamps associated with a respective input of the received input and at least one location in a document associated with the video content; and
synchronizing the input includes matching, for the respective input, at least one timestamp in the plurality of timestamps, to the at least one location in the document.

19. The non-transitory computer-readable storage medium of claim 16, wherein the transcription video stream includes:
real-time transcribed audio data from the presenter video stream generated as textual data configured for display with the screencast video stream during the recording of the video content; and
real-time translated audio data from the presenter video stream generated as textual data configured for display with the screencast video stream and the transcribed audio data during the recording of the video content.

20. The non-transitory computer-readable storage medium of claim 19, wherein:
the real-time transcribed audio data is generated as modifiable transcription data configured for display with the screencast video stream during the recording of the video content;
transcription of the real-time transcribed audio data is performed by at least one speech-to-text application, the at least one speech-to-text application selected from a plurality of speech-to-text applications determined to be accessible by the transcription video stream; and
the modifiable transcription data and the textual data are stored according to timestamp in the metadata record and are configured to be searchable.

21. The non-transitory computer-readable storage medium of claim 16, wherein the input includes annotation input associated with the annotation video stream, the annotation input including video marker data and telestrator data generated by a user associated with the presenter video stream.

22. The non-transitory computer-readable storage medium of claim 16, wherein the presenter video stream, the screencast video stream, the transcription video stream, and the annotation video stream are configured to be toggled on and off during the recording, the toggling on and off triggering display or removal from display of the respective presenter video stream, the respective screencast video stream, the respective transcription video stream, or the respective annotation video stream.

23. A non-transitory computer-readable storage medium comprising instructions stored thereon that, when executed by at least one processor, are configured to cause a computing system to carry out instructions including:
causing a recording to begin capturing audio content and video content, the video content including at least a presenter video stream, a screencast video stream, a transcription video stream, and an annotation video stream;
causing rendering of the audio content and the video content associated with access of a plurality of applications from within a user interface;
receiving annotation input in the user interface during rendering of the audio content and the video content, the annotation input being recorded in the annotation video stream;
transcribing the audio content during the rendering of the audio content and video content, the transcribed audio content being recorded in the transcription video stream;
translating the transcribed audio content during the rendering of the audio content and video content; and
causing rendering of the transcribed audio content and the translation of the transcribed audio content in the user interface with the rendered audio content and video content.

24. The non-transitory computer-readable medium of claim 23, wherein the instructions further include:
generate content representative of at least a portion of the audio content and the video content, in response to detecting termination of the rendering of the video content and the audio content, the representative content being based on the annotation input, the video content, and transcribed audio content, and the translated audio content, wherein the representative content includes portions of the rendered audio and video marked with the annotation input.

25. The non-transitory computer-readable medium of claim 23, wherein the annotation input is caused to be rendered as an overlay on the video content, the annotation input being configured to move with the video content in response to detecting a window event or cursor event triggering a switch to other video content accessed during the recording.

26. A computer-implemented method comprising:
receiving at least one video stream;
receiving metadata representing timing information associated with input detected in the at least one video stream, the timing information configured to synchronize the detected input provided in the at least one video stream to content depicted in the at least one video stream;
in response to receiving a request to view the at least one video stream, generating portions of the at least one video stream, the generating being based on the metadata and a detected user indication requesting to view a representation of the at least one video stream; and
causing rendering of the portions of the at least one video stream.

27. The computer-implemented method of claim 26, wherein the timing information corresponds to a plurality of timestamps associated with a respective input detected in the at least one video stream and at least one location in content associated with the at least one video stream; and
synchronizing the detected input includes matching, for a respective input, at least one timestamp to the at least one location in a document associated with the at least one video stream.

28. The computer-implemented method of claim 26, wherein the at least one video stream is selected from a presenter video stream, a screencast video stream, a transcription video stream, and an annotation video stream.

29. The computer-implemented method of claim 26, wherein the representation of the at least one video stream is based on the detected input and includes the rendered portions of the at least one video stream annotated with the input.
